(19) United States
(12) Patent Application Publication
(10) Pub. No.: US 2013/0219212 A1
(43) Pub. Date: Aug. 22, 2013

(54) ARRAY MANAGEMENT DEVICE, ARRAY MANAGEMENT METHOD AND INTEGRATED CIRCUIT

(71) Applicants: Yoshiki Terada, Osaka (JP); Shohji Ohtsubo, Osaka (JP); Katsuhiko Hirose, Osaka (JP)

(72) Inventors: Yoshiki Terada, Osaka (JP); Shohji Ohtsubo, Osaka (JP); Katsuhiko Hirose, Osaka (JP)

(21) Appl. No.: 13/881,501

(22) PCT Filed: Oct. 18, 2011
(86) PCT No.: PCT/JP2011/005805

§ 371 Date: Apr. 25, 2013

(30) Foreign Application Priority Data
Dec. 15, 2010 (JP) 2010-279219

(51) Int. Cl. G06F 11/20

(52) U.S. Cl. CPC G06F 11/2089
USPC 714/6.21

(57) ABSTRACT

To provide an array management device that changes criterion for judging whether to execute re-redundancy in accordance with configuration type of communication path. An array management device that executes redundancy on storage devices, and controls access to each storage device includes: a judgment unit judging whether access to each storage device has succeeded or failed; a holding unit holding therein configuration type of communication path to each storage device; a derivation unit, for each storage device, deriving a waiting period in accordance with the configuration type, the waiting period being from failure of access to the storage device to start of redundancy; and a redundancy processing unit, when access to a given storage device is judged to have failed, and then access to the given storage device is not judged to have succeeded within the waiting period, executing redundancy on the storage devices other than the given storage device.

### TECHNICAL FIELD

The present invention relates to an array management device that manages an array configured by executing redundancy processing on a plurality of storage devices.

### BACKGROUND ART

Generally, the RAID (Redundant Arrays of Inexpensive Disks) technology is used for the storage array system in order to increase the capacity size, the performance, or the reliability.

It is well known that the reliability can be increased in each mode of RAID level 1 to RAID level 6 by the redundancy configuration. Furthermore, there are a configuration in which a special mode other than RAID level 1 to RAID level 6 is used and a configuration in which a combination of a plurality of modes is used.

According to the mode called RAID level 5 for example, among storage devices managed by the array management device, the tolerable number of storage devices in which storage failure occurs is one. In this case where storage failure occurs in one storage device, the storage array system temporarily shifts to so-called a degraded state. In the case where storage failure simultaneously occurs in each of two or more storage devices, the array logically breaks down, and as a result part or all of data stored in the array cannot be extracted. The tolerable number of storage devices in which storage failure occurs differs depending on the RAID configuration.

In the degraded state, a storage device in which failure occurs is replaced with a normal storage device, and then a command for recovery is transmitted to the storage array system automatically or by a manager. This enables the array to recover data from one or more other storage devices managed therein and copy the recovered data to the normal storage device replaced with. As a result, the storage array system can restore from the degraded state to a normal state.

Also, there is a storage array system that further increases the reliability with use of a spare storage device. Generally, a spare storage device is in a waiting state until the storage array system shifts to the degraded state, and when the storage array system shifts to the degraded state, a storage device in which storage failure occurs is logically replaced with the spare storage device.

Furthermore, there is a storage array system in which, when storage failure is detected, the redundancy configuration in one or more other storage devices managed in the storage array system is automatically changed, thereby to attempt to recover the redundancy without replacing the storage device in which failure occurs (see Patent Literature 1).

Also, each storage array system is executed in accordance with any of various types of storage architectures such as the NAS (Network Attached Storage) environment, the SAN (Storage Area Network) environment, and an environment directly connected to a client computer or a host computer via a storage interface.

Each storage device is connected to a network for data transfer or management in the storage array system. The term “network” used here of course includes “IP (Internet Protocol) network”, but is not limited to this.

Generally, in the case where communication with a storage device becomes unavailable due to disconnection of a connection cable, shutdown of network, or the like, the storage array system shifts to the degraded state, in the same way as in the case where storage failure occurs (see Patent Literature 2).

### CITATION LIST

### Patent Literature

[Patent Literature 1] Japanese Patent Application Publication No. 2008-519359
[Patent Literature 2] Japanese Patent No. 4520802

### SUMMARY OF INVENTION

### Technical Problem

In the storage array system of the art disclosed in Patent Literature 2, each time the network is shut down, processing for restoring to the normal state is executed in the same way as in the case where storage failure occurs. The processing is specifically processing of replacing with a spare storage device, re-redundancy processing on one or more other storage devices managed by the storage array system.

However, the shutdown of the network communication occurs due to a different cause depending on the type of network (configuration type of communication path). The type of network indicates, for example, whether the network communication is wired-connected or wireless-connected, whether the network communication is connected via the Internet or within a local area, and so on. In the case where the network communication is wireless-connected for example, when there is any obstacle between devices that perform wireless communication therebetween, the communication becomes unavailable and as a result the network communication is temporarily shut down until the obstacle is removed. Furthermore, in the case where the network communication is connected via the Internet, when the network traffic amount is large, transmission and reception of data delays, and as a result the network communication might be judged to have shut down. In these cases, the storage devices themselves have not broken down, and furthermore there is a possibility that the network communication recovers automatically after elapse of a period.

For this reason, it is not preferable to execute re-redundancy processing immediately after shutdown of the network communication despite that automatic recovery is expected. This is because that re-redundancy processing needs reading and writing of a large amount of data, and this results in reduction in life-span of the storage devices.

In view of the above problem, the present invention aims to provide an array management device, an array management method, and an integrated circuit that are capable of changing a criterion for judging whether to execute re-redundancy processing in accordance with the configuration type of the communication path.

### Solution to Problem

In order to achieve the above aim, the present invention provides an array management device that executes redundancy processing on a plurality of storage devices, and controls access to each of the plurality of storage devices, the array management device comprising: a judgment unit configured to judge whether access to each of the plurality of storage devices has succeeded or failed; a holding unit configured to hold therein a configuration type of a communication path to each of the plurality of storage devices; a derivation unit configured, with respect to each of the plurality of storage devices, to derive a waiting period in accordance with the configuration type held in the holding unit, the waiting period being from when access to the storage device has failed to when execution of redundancy processing is to be started; and a redundancy processing unit configured, when the judgment unit judges that access to a given one of the plurality of storage devices has failed, and then does not judge that access to the given storage device has succeeded within the waiting period derived by the derivation unit in accordance with the configuration type of the communication path to the given storage device, to execute redundancy processing on the plurality of storage devices other than the given storage device.

### Advantageous Effects of Invention

With the above configuration, the array management device derives the waiting period for necessary to start executing redundancy processing in accordance with the configuration type of the communication path of the storage device to which access has failed. Accordingly, the array management device can change the waiting period necessary for judging that re-redundancy processing is to be executed, that is, the criterion for judging to execute re-redundancy processing, in accordance with the configuration type of the communication path. As a result, when access succeeds within the waiting period, it is unnecessary to execute re-redundancy processing. Accordingly, the life-span of the storage device is longer compared with the case where re-redundancy processing is executed immediately after occurrence of failure.

### BRIEF DESCRIPTION OF DRAWINGS

FIG. 1 shows the configuration of an array management system 1 relating to an embodiment.

FIG. 2 is a block diagram showing the configuration of an array management device 100.

FIG. 3 shows an example of the data structure of a network state management table T100.

FIG. 4 shows an example of the data structure of a storage state management table T200.

FIG. 5 shows an example of the data structure of a network failure management table T300.

FIG. 6 shows an example of the data structure of a free area information table T400.

FIG. 7 shows an example of the data structure of a data temporary save area information table T500.

FIG. 8 is a block diagram showing the configuration of a storage device 11.

FIG. 9 is a flow chart showing network state monitoring processing.

FIG. 10 is a flow chart showing heartbeat check processing on a storage device.

FIG. 11 is a flow chart showing recovery check processing on a storage device.

FIG. 12 is a flow chart showing processing of determining a redundancy policy at non-response of a storage device.

FIG. 13 is a flow chart showing processing of determining a redundancy policy at recovery of a storage device.

FIG. 14 is a flow chart showing access processing in a normal state.

FIG. 15 is a flow chart showing writing processing performed at occurrence of network failure.

FIG. 16 is a flow chart showing reading processing performed at occurrence of network failure.

FIG. 17 is a flow chart showing recovery processing from network failure.

FIG. 18 is a flow chart showing operations of the array management device 100 at non-response of a storage device.

FIG. 19 shows shift from a normal state to execution of re-redundancy.

FIG. 20A shows a specific example of data writing in a normal state, and FIG. 20B shows a specific example of data writing in a temporary save state.

FIG. 21 shows a specific example of re-redundancy.

FIG. 22 shows an example of the data structure of a policy determination table T600.

FIG. 23 shows an example of the configuration of an array management device 100A whose operations are realized by program execution.

FIG. 24 shows an example of the configuration of a storage device 11A whose operations are realized by program execution.

FIG. 25 shows the configuration of an array management device 3000 relating to the present invention.

FIG. 26 shows the configuration of an array management device 3000A relating to the present invention.

FIG. 27 shows an array management method relating to the present invention.

### DESCRIPTION OF EMBODIMENTS

The following describes an embodiment of the present invention, with reference to the drawings.

### 1. Embodiment

The embodiment relating to the present invention is described with reference to the drawings.

1.1 Outline

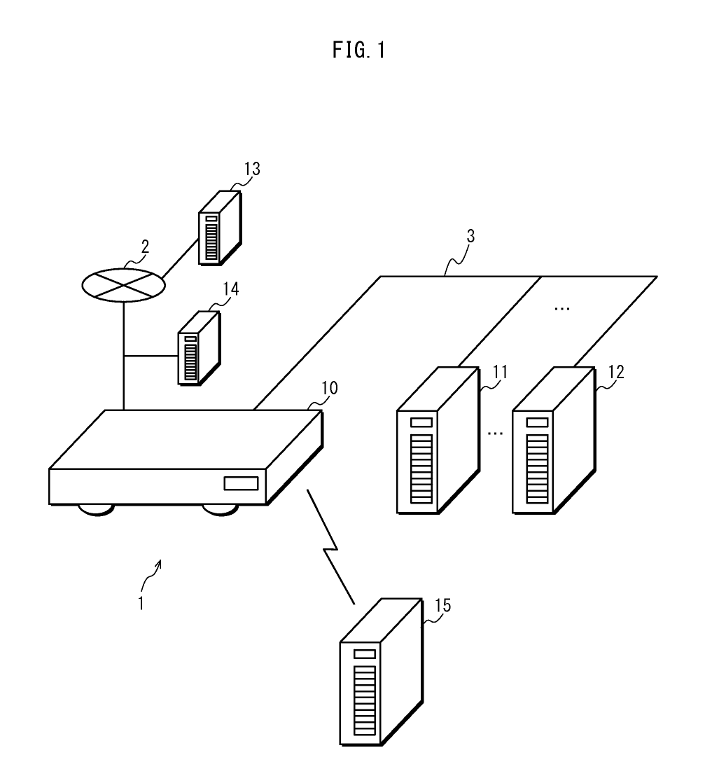

FIG. 1 shows the configuration of an array management system 1 that includes an array management device relating to the present invention.

The array management system 1 shown in FIG. 1 includes a digital recorder 10 including an array management device 100 which is described later, and storage devices 11-15. Here, the storage device 12 is a spare storage device.

The digital recorder 10 manages and saves digital data such as image data photographed by a digital camera. The digital recorder 10 incorporates the array management device 100 therein, and accordingly can redundantly save such digital data in the storage devices 11-15.

The storage devices 11 and 12 are each locally connected with the digital recorder 10 via a USB (Universal Serial Bus), an SCSI (Small Computer System Interface), or the like. Also, the storage device 13 is connected with the digital recorder 10 via an Internet 2, and the storage device 14 is connected with the digital recorder 10 via a LAN (Local Area Network). Furthermore, the storage device 15 is connected with the digital recorder 10 via a wireless local network. Note that connection with each of the storage devices may be realized using, as a network and interface thereof, Ethernet™, Fiber Channel, USB, IEEE1394 (Institute of Electrical and Electronic Engineers 1394), IDE (Integrated Drive Electronics), Serial ATA (Advanced Technology Attachment), eSATA (external Serial ATA), SCSI, SAS (Serial Attached SCSI), or the like.

In the same manner as conventional arts, the array management device 100 monitors whether storage failure occurs in each of the storage devices such as breakdown, and when detecting storage failure, re-configures redundancy. Here, re-configuration of redundancy is hereinafter referred to as re-redundancy.

Also, the array management device 100 also monitors whether network failure occurs in a network connected with each of the storage devices. Here, network failure in the present embodiment indicates continuation of non-response from a storage device for a predetermined period or more after transmission of a response request for heartbeat check. When detecting network failure in a storage device, the array management device 100 waits for the storage device to recover from the network failure for a period determined in accordance with the network connection mode. In the case where the storage device does not recover even after the period has elapsed, the array management device 100 re-configures redundancy.

While waiting for the storage device to recover from the network failure, the array management device 100 cannot write data to the storage device in which the network failure occurs. For this reason, the array management device 100 writes, to one or more other storage devices such as a storage device prepared as a spare storage device (the storage device 12 in the present embodiment), a storage device having a large free capacity, or the like, the data that is to be written originally to the storage device in which the network failure occurs. This prevents overflow in a cache for temporarily saving data. Here, the free capacity is a capacity included in an area that is not used for the array configuration, and to which data has not yet been written.

1.2 Configuration of Array Management Device 100

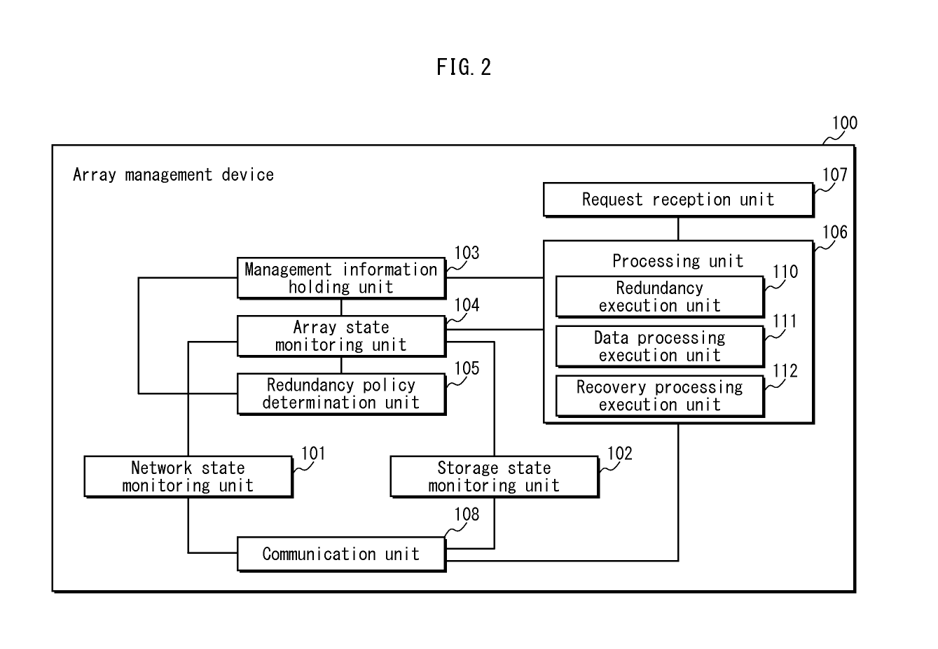

The array management device 100 is a device that manages the storage devices 11-15. As shown in FIG. 2, the array management device 100 includes a network state monitoring unit 101, a storage state monitoring unit 102, a management information holding unit 103, an array state monitoring unit 104, a redundancy policy determination unit 105, a processing unit 106, a request reception unit 107, and a communication unit 108.

(1) Network State Monitoring Unit 101

The network state monitoring unit 101 monitors whether network failure occurs in each of the storage devices 11-15.

Specifically, upon receiving, from the array state monitoring unit 104, a request instruction to issue a response request to each of the storage devices 11-15, the network state monitoring unit 101 transmits a response request to the storage device. The network state monitoring unit 101 performs heartbeat check on the storage device on the network, depending on whether receiving a response to the response request within a predetermined period T0 such as one second.

If receiving a response from the storage device within the predetermined period T0 after transmission of the response request, the network state monitoring unit 101 notifies the array state monitoring unit 104 of response check information indicating reception of the response.

If receiving no response from the storage device within the predetermined period T0 after transmission of the response request, the network state monitoring unit 101 notifies the array state monitoring unit 104 of non-response information indicating reception of no response.

(2) Storage State Monitoring Unit 102

In the same manner as conventional arts, the storage state monitoring unit 102 monitors whether storage failure occurs in each of the storage devices 11-15.

The storage state monitoring unit 102 regularly checks each of the storage devices 11-15 as to whether storage failure occurs such as whether breakdown of a disc occurs.

When judging that storage failure occurs, the storage state monitoring unit 102 notifies the array state monitoring unit 104 of storage failure information indicating occurrence of storage failure.

(3) Management Information Holding Unit 103

The management information holding unit 103 is a memory area for holding a plurality of types of tables managed by the array management device 100.

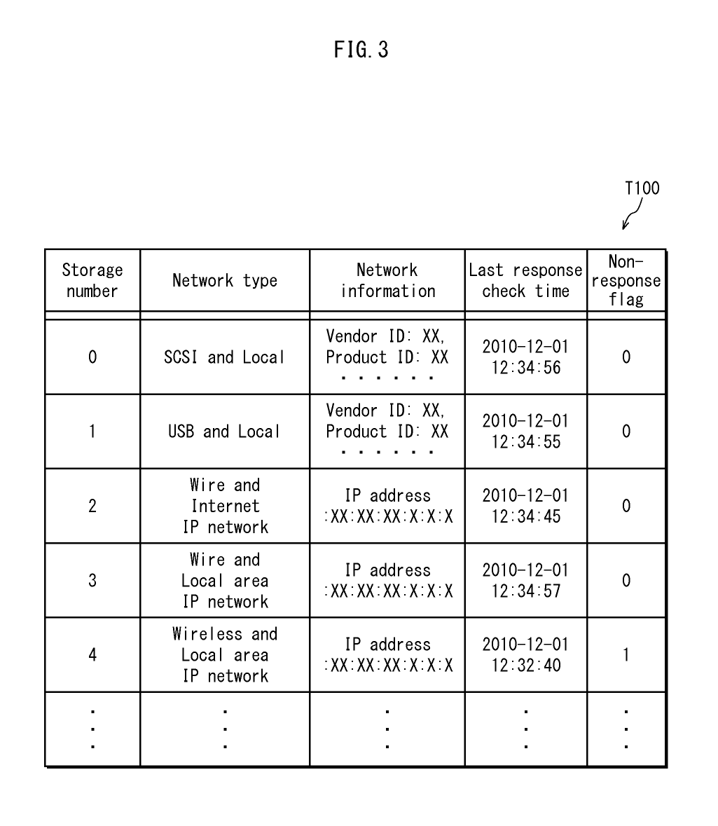

The management information holding unit 103 holds therein tables shown in FIG. 3 to FIG. 7, specifically a network state management table T100, a storage state management table T200, a network failure management table T300, a free area information table T400, and a data temporary save area information table T500. The management information holding unit 103 also holds therein information indicating the array configuration such as an array configuration information table which is not illustrated, in the same manner as conventional arts. The information indicating the array configuration is known, and accordingly detail description thereof is omitted here. The array configuration information table has an area for holding a plurality of combinations each composed of an array number, a redundancy method, the number of storage devices, a storage number, and an array capacity. The array number is a number identifying the configured array. The redundancy method is a method of executing redundancy processing such as RAID 1 and RAIDS. The number of storage devices is the number of storage devices that configure the array. The storage number is a number identifying each of the storage devices that configure the array. The array capacity is the total capacity of the configured array. Note that a spare storage device is also managed in the array configuration information table.

(3-1) Network State Management Table T100

The network state management table T100 is a table that manages the state of the network such as whether a response is received in response to a response request. As shown in FIG. 3, the network state management table T100 has an area for holding a plurality of combinations each composed of a storage number, a network type, network information, the last response check time, and a non-response flag.

The storage number is a number uniquely identifying each of the storage devices connected with the array management device 100.

The network type indicates the connection mode of network connected with the storage device identified by the storage number. As the network type, an operator of the system has written beforehand, for example, whether wired connection or wireless connection, whether LAN connection or Internet connection, and whether the network has assigned thereto an IP address.

The network information is information that is necessary for transmitting a response request and is for identifying storage devices as the same on the network. The network information differs for each network type. For example, the network type indicating IP network corresponds to the network information indicating IP address, MAC address, or the like. Also, the network type indicating USB network corresponds to the network information indicating vendor ID, product ID, serial number, or the like.

The last response check time is a time when the array state monitoring unit 104 has lastly received response check information corresponding to each of the storage devices. Each time the array state monitoring unit 104 receives response check information, the last response check time is updated.

The non-response flag is a flag indicating whether the array state monitoring unit 104 has received non-response information. The non-response flag having a value of zero indicates no reception of non-response information, in other words, reception of response check information. The non-response flag having a value of one indicates reception of non-response information.

(3-2) Storage State Management Table T200

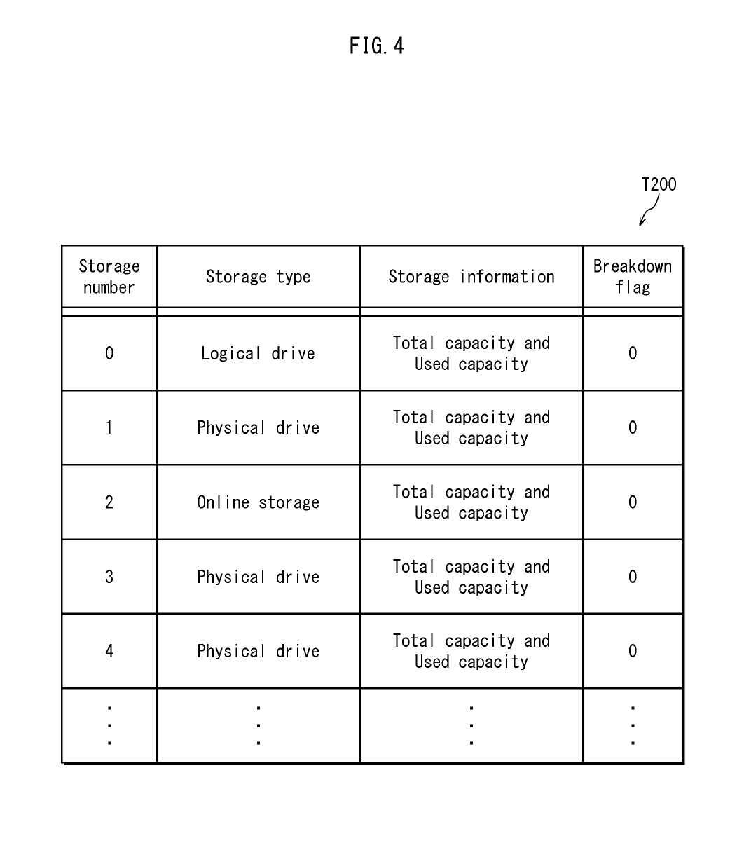

The storage state management table T200 is a table that manages the state of each of the storage devices such as whether breakdown occurs. As shown in FIG. 4, the storage state management table T200 has an area for holding a plurality of combinations each composed of a storage number, a storage type, storage information, and a breakdown flag.

The description on the storage number has been already given, and accordingly is omitted here.

The storage type is information indicating the type of configuration of each of the storage devices, such as logical drive, physical drive, and online storage device. The online storage device here is one type of high reliable storage devices. A high reliable storage device is a storage device that protects data itself, and is extremely unlikely to break down. For example, an online storage device, a redundancy array virtualized as a single storage device, and the like are each one type of high reliable storage devices. For example, a storage device having a storage type indicating online storage device is a high reliable storage device. Also, although not shown in FIG. 4, in the case where a redundancy array is virtualized as a single storage device, information indicating virtualization of the redundancy array as a single storage device is written in the storage type. In the case where a storage type of a storage device has written therein information indicating an online storage device or a redundancy array is virtualized as a single storage device, the array management device 100 judges that the storage device is a high reliable storage device.

The storage information includes information indicating the total capacity and the used capacity corresponding to each of the storage devices, for example.

The breakdown flag is a flag indicating whether the array state monitoring unit 104 has received storage failure information. The breakdown flag having a value of zero indicates no reception of storage failure information. The breakdown flag having a value of one indicates reception of storage failure information.

(3-3) Network Failure Management Table T300

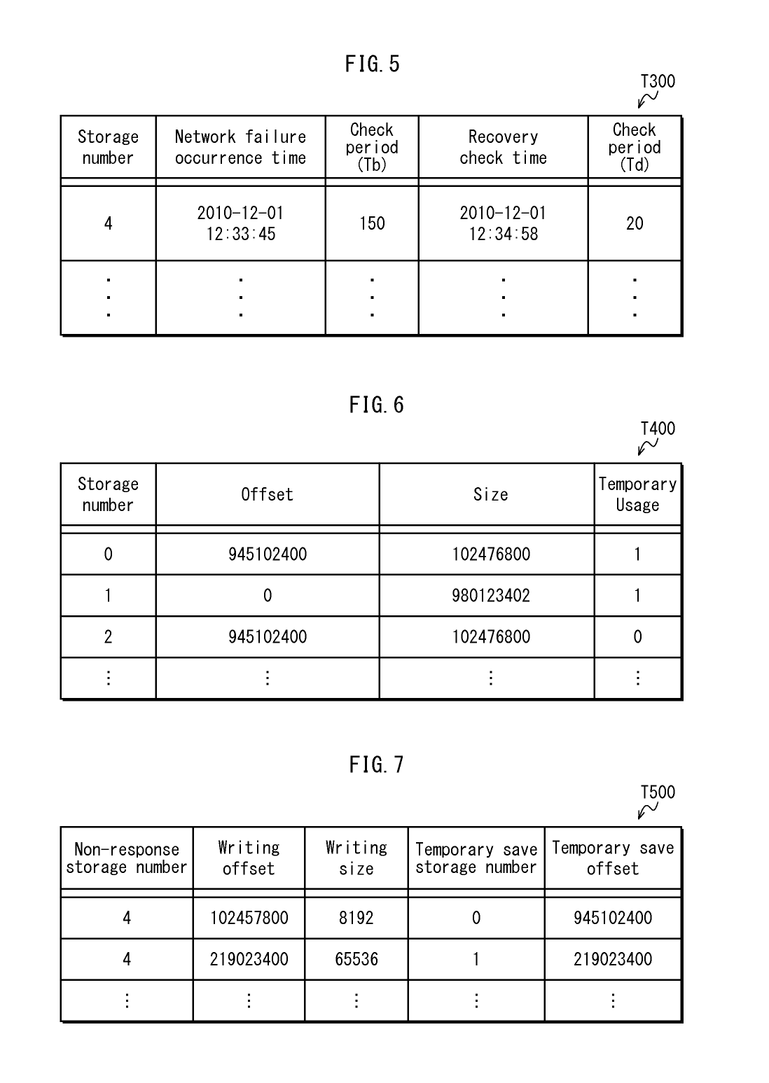

The network failure management table T300 is a table that manages, with respect to a storage device in which network failure occurs, an occurrence time of network failure and a recovery time. As shown in FIG. 5, the network failure management table T300 has an area for holding a plurality of combinations each composed of a storage number, a network failure occurrence time, a check period Tb, a recovery check time, and a check period Td. A combination, which is composed of a storage number, a network failure occurrence time, a check period Tb, a recovery check time, and a check period Td, is hereinafter referred to as network failure information.

The description on the storage number has been already given, and accordingly is omitted here.

The network failure occurrence time is a time when the array state monitoring unit 104 judges that network failure has occurred.

The check period Tb is a waiting period from occurrence of network failure to start of execution of re-redundancy, in other words, a period in which recovery is expected.

The recovery check time is a time when a response to a response request by the network state monitoring unit 101 has been received within the check period Tb.

The check period Td is a period from the recovery check time to a time when the communication state of the network is estimated to become stabilized.

(3-4) Free Area Information Table T400

The free area information table T400 is a table that manages a free capacity of each of the storage devices 11-15. As shown in FIG. 6, the free area information table T400 has an area for holding a plurality of combinations each composed of a storage number, an offset, a size, and temporary usage. As described above, the free capacity is a capacity included in an area that is not used for the array configuration, and to which data has not yet been written.

The description on the storage number has been already given, and accordingly is omitted here.

The offset is a value indicating a start position in the free area.

The size is a value indicating the capacity of the free area.

The temporary usage of each of the storage devices indicates whether a corresponding storage device temporarily saves data that is to be written originally to other storage device in which network failure occurs. The temporary usage having a value of zero indicates that the corresponding storage device is not temporarily used. The temporary usage having a value of one indicates that the corresponding storage device is temporarily used.

(3-5) Data Temporary Save Area Information Table T500

The data temporary save area information table T500 is a table that manages a temporary save destination of data that is to be written originally to a storage device in which network failure occurs. As shown in FIG. 7, the data temporary save area information table T500 has an area for holding a plurality of combinations each composed of a non-responding storage number, a writing offset, a writing size, a temporary save storage number, and a temporary save offset. A combination, which is composed of a non-responding storage number, a writing offset, a writing size, a temporary save storage number, and a temporary save offset, is hereinafter referred to as temporary save area information.

The non-responding storage number is a storage number identifying a storage device in which network failure is judged to have occurred.

The writing offset indicates a writing position in the storage device, which is identified by the non-responding storage number, where data is to be originally written.

The writing size is a size of data that is to be written to the storage device identified by the non-responding storage number.

The temporary save storage number is a storage number identifying a storage device that temporarily saves data indicated by corresponding writing offset and writing size.

The temporary save offset indicates a writing position in a storage device where the data, which is indicated by the corresponding writing offset and writing size, is temporarily saved.

(4) Redundancy Policy Determination Unit 105

The redundancy policy determination unit 105 sets a reference period Ta for judging that network failure occurs in a non-responding storage device. The reference period Ta is also a waiting period until start of temporary save for preventing overflow in the cache.

Also, in the case where network failure occurs in a storage device, the redundancy policy determination unit 105 derives a period Tb necessary for judging that re-redundancy processing is to be executed in accordance with the network connection mode (network type) of the storage device.

For example, with respect to the storage device 15, which is network-connected via a wireless communication, in the case where an obstacle exists between the storage device 15 and a device that perform wireless communication therebetween, a wireless signal is interrupted by the obstacle. This is likely to cause occurrence of network failure in the storage device 15 despite of that the storage device 15 itself is normal. In such a situation, by removing the obstacle, resumption of the normal wireless communication can be expected. Accordingly, the redundancy policy determination unit 105 derives a new period Tb that is longer than a period Tb that has been set as the initial value.

Also, with respect to the storage device 11, which is network-connected via a dedicated cable such as a USB, in the case where the storage device 11 transmits no response to a response request, failure is likely to occur in the storage device 11 itself rather than in the cable. For this reason, the redundancy policy determination unit 105 derives a new period Tb that is shorter than a period Tb that has been set as the initial value.

Specifically, with respect to a storage device that is expected to recover from network failure after elapse of a period, the redundancy policy determination unit 105 sets a new period Tb that is longer than the initial value Tb, as a waiting period necessary for judging that re-redundancy processing is to be executed. On the contrary, with respect to a storage device that is not expected to recover from network failure even after elapse of a period, the redundancy policy determination unit 105 sets a period Tb that is shorter than the initial value Tb, as a waiting period necessary for judging that re-redundancy processing is to be executed.

Furthermore, when the storage device is checked to have recovered from the network failure, the redundancy policy determination unit 105 derives a period Td necessary for the network state to become stabilized after recovery, in accordance with the network connection mode.

(5) Array State Monitoring Unit 104

The array state monitoring unit 104 monitors the array state. Specifically, with respect to each of the storage devices 11-15, the array state monitoring unit 104 monitors the network failure state and the failure state of the array configuration based on results of monitoring performed by the network state monitoring unit 101 and the storage state monitoring unit 102.

With respect to each of the storage devices whose network state is to be monitored, the array state monitoring unit 104 notifies the network state monitoring unit 101 of information necessary for issuing a response request to the storage device (network information shown in FIG. 3) and a request instruction. Then, the array state monitoring unit 104 updates the network state management table T100 based on results of monitoring performed by the network state monitoring unit 101.

With respect to a target storage device that has become non-responding, the array state monitoring unit 104 counts time from detection of non-response to reception of response check information. If not receiving response check information of the target storage device within the period Ta, the array state monitoring unit 104 judges that network failure occurs in the target storage device, and notifies the processing unit 106 of occurrence of network failure, and furthermore counts time from judgment that re-redundancy processing is to be executed to reception of response check information of the target storage device. Also, with respect to the target storage device in which the network failure occurs, the array state monitoring unit 104 updates the network failure management table T300.

If the array state monitoring unit 104 does not receive response check information of the target storage device within the period Tb, the processing unit 106 executes re-redundancy processing.

If receiving response check information of the target storage device within the period Tb, the array state monitoring unit 104 counts time until the period Td has elapsed. Also, the array state monitoring unit 104 updates the network failure management table T300 with use of a time at reception of the response check information and the period Td. If receiving non-response information on the target storage device within the period Td, the array state monitoring unit 104 again counts time until the period Tb has elapsed. If not receiving non-response information on the target storage device within the period Td, the array state monitoring unit 104 notifies the processing unit 106 of recovery information indicating recovery from the network failure, and updates the network failure management table T300 and the network state management table T100.

With respect to each target storage device whose storage state is to be monitored, the array state monitoring unit 104 notifies the storage state monitoring unit 102 of information necessary for accessing the target storage device.

Furthermore, if reading or writing of data by the processing unit 106 has failed, the array state monitoring unit 104 controls the storage state monitoring unit 102 to check the storage state of the target storage device. If storage failure occurs in the target storage device, the array state monitoring unit 104 updates the breakdown flag included in the storage state management table T200.

Also, if reading or writing of data by the processing unit 106 has succeeded, the array state monitoring unit 104 updates the last response check time included in the network state management table T100, with respect to each storage device on which reading or writing has been performed.

(6) Processing Unit 106

The processing unit 106 performs, on each of the storage devices, reading and writing of data, re-redundancy processing, and recovery processing of recovering from network failure. As shown in FIG. 2, the processing unit 106 includes a redundancy execution unit 110, a data processing execution unit 111, and a recovery processing execution unit 112.

(6-1) Redundancy Execution Unit 110

Upon receiving a re-redundancy instruction from the array state monitoring unit 104, the redundancy execution unit 110 executes re-redundancy processing.

Specifically, the redundancy execution unit 110 executes redundancy processing, on a spare storage device (the storage device 12 here) and the storage devices other than a storage device in which failure occurs that is specified with use of the network state management table T100 and the storage state management table T200. Redundancy processing is specifically executed as follows. Data is recovered that is to be stored in the storage device in which the failure occurs, with use of all the pieces of data stored in the storage devices that configure the array other than the storage device in which the failure occurs excepting data that is temporarily saved. Then, all the recovered pieces of data are written to the spare storage device.

Note that, with respect to data written after failure has occurred, data, which is temporarily saved in one or more other storage devices as data to be written to the storage device in which the failure occurs, may be written to a spare storage device without modification, with use of the data temporary save area information table T500.

(6-2) Data Processing Execution Unit 111

The data processing execution unit 111 reads and writes data from and to each of the storage devices.

The data processing execution unit 111 performs different functional operations depending on whether network failure occurs or not. Accordingly, description is given separately on the case where failure occurs and the case where no failure occurs. By judging whether the network failure management table T300 includes network failure information, it is possible to judge whether network failure occurs in the storage device.

(Case where No Network Failure Occurs)

Firstly, description is given on functional operations in the case where no network failure occurs.

When reading or writing data from or to each target storage device in accordance with an instruction issued by an external device via the request reception unit 107, the data processing execution unit 111 transmits a reading instruction or a writing instruction to the target storage device.

Then, if receiving a response from the target storage device within the predetermined period T0, the data processing execution unit 111 notifies the array state monitoring unit 104 of response check information, a storage number identifying the target storage device in the same manner as the network state monitoring unit 101, and also reads or writes data to the target storage device. If reading or writing the data has failed, the data processing execution unit 111 notifies the array state monitoring unit 104 of the storage number identifying the target storage device in which reading or writing has failed and unsuccess information indicating that the reading or writing has failed. Furthermore, the data processing execution unit 111 notifies the external device of the unsuccess information via the request reception unit 107. If reading or writing the data has succeeded, the data processing execution unit 111 notifies the external device of success in reading or writing via the request reception unit 107.

If receiving no response from the target storage device within the predetermined period T0, the data processing execution unit 111 notifies the array state monitoring unit 104 of the storage number identifying the non-responding target storage device and non-response information.

(Case where Network Failure Occurs)

Next, description is given on functional operations in the case where network failure occurs.

Firstly, functional operations performed at writing data are described.

The data processing execution unit 111 writes data that is to be written to a storage device in which network failure occurs, to a storage device that has a capacity enough to temporarily save the data among the storage devices other than the storage device in which the network failure occurs.

The data processing execution unit 111 updates the area information table T400 and the data temporary save area information table T500, with respect to a free capacity of the storage device in which the data is temporarily saved.

Next, functional operations performed at reading data are described.

In the case where data that is to be read from a storage device in which network failure occurs is temporarily saved in one or more other storage devices, the data processing execution unit 111 reads the data from the other storage devices. If the data, which is to be read from the storage device in which the network failure occurs, is not temporarily saved and is recoverable with use of redundant data, the data processing execution unit 111 recovers the data to be read with use of the redundant data. If the data to be read is unrecoverable, the data processing execution unit 111 notifies the request reception unit 107 of a reading error.

The data processing execution unit 111 repeatedly performs these functional operations until reading of all the pieces of data is complete.

(6-3) Recovery Processing Execution Unit 112

Upon receiving recovery information from the array state monitoring unit 104, the recovery processing execution unit 112 writes data back to a storage device that has recovered from network failure.

Specifically, the recovery processing execution unit 112 writes data that has been temporarily written, back to a storage device originally to which the data is to be written (the recovered storage device), with use of temporary save area information corresponding to the recovered storage device.

The recovery processing execution unit 112 deletes, from the data temporary save area information table T500, the temporary save area information relating to the data which has been written back.

Also, the recovery processing execution unit 112 updates the free capacity included in the free area information table T400. Specifically, the recovery processing execution unit 112 updates the free capacity of a storage device that is a temporary save destination and the free capacity of the storage device to which the data has been written back.

The recovery processing execution unit 112 repeatedly performs these functional operations until there is no temporary save area information corresponding to a storage device that has recovered.

(7) Request Reception Unit 107

The request reception unit 107 receives a request to read or write data from an external device, and outputs the received request to the processing unit 106. When receiving a request to read data, the request reception unit 107 further receives a reading position, and further outputs the received reading position to the processing unit 106. Also, when receiving a request to write data, the request reception unit 107 further receives data to be written, and further outputs the received data to the processing unit 106.

Furthermore, upon receiving an error notification from the processing unit 106, the request reception unit 107 outputs the received error notification to the external device.

(8) Communication Unit 108

The communication unit 108 inputs and outputs data to and from each of the storage devices 11-15 that are targets for management.

1.3 Storage Devices 11-15

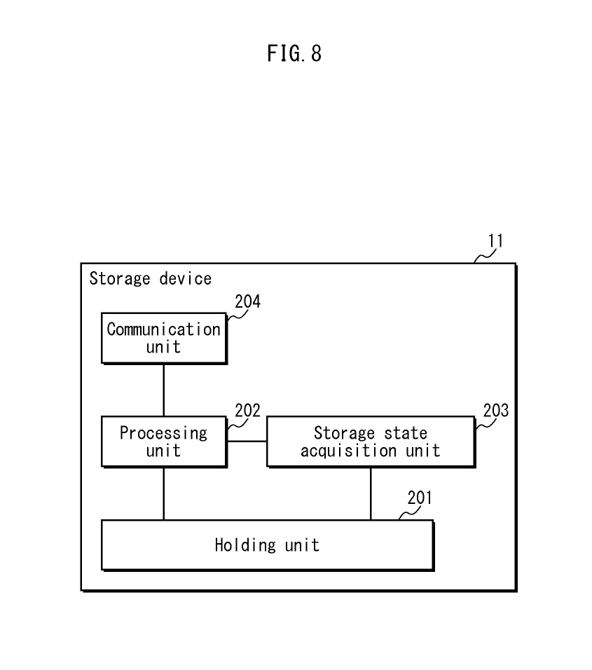

The storage devices 11-15 have the same configuration elements, and accordingly description is given on the configuration elements of the storage device 11 with reference to FIG. 8.

The storage device 11 includes, as shown in FIG. 8, a holding unit 201, a processing unit 202, a storage state acquisition unit 203, and a communication unit 204.

(1) Holding Unit 201

The holding unit 201 is a large capacity recording device that holds therein data written by the array management device 100, and is an HDD (Hard Disk Drive), an SSD (Solid State Drive), or the like.

(2) Processing Unit 202

In accordance with an instruction issued by the array management device 100, the processing unit 202 writes data received from the array management device 100 to the holding unit 201, and also reads data from the holding unit 201 and transmits the read data to the array management device 100 via the communication unit 204.

Also, upon receiving a response request from the array management device 100 via the communication unit 204, the processing unit 202 transmits a response to the response request to the array management device 100 via the communication unit 204.

Furthermore, upon receiving breakdown information indicating that the holding unit 201 has broken down from the storage state acquisition unit 203, the processing unit 202 notifies the array management device 100 of the breakdown information via the communication unit 204.

(3) Storage State Monitoring Unit 203

The storage state acquisition unit 203 checks whether the holding unit 201 has broken down. In the case where the holding unit 201 has broken down, the storage state acquisition unit 203 notifies the processing unit 202 of breakdown information when the array management device 100 checks the storage state.

1.4 Operations

The following describes the operations of the array management device 100.

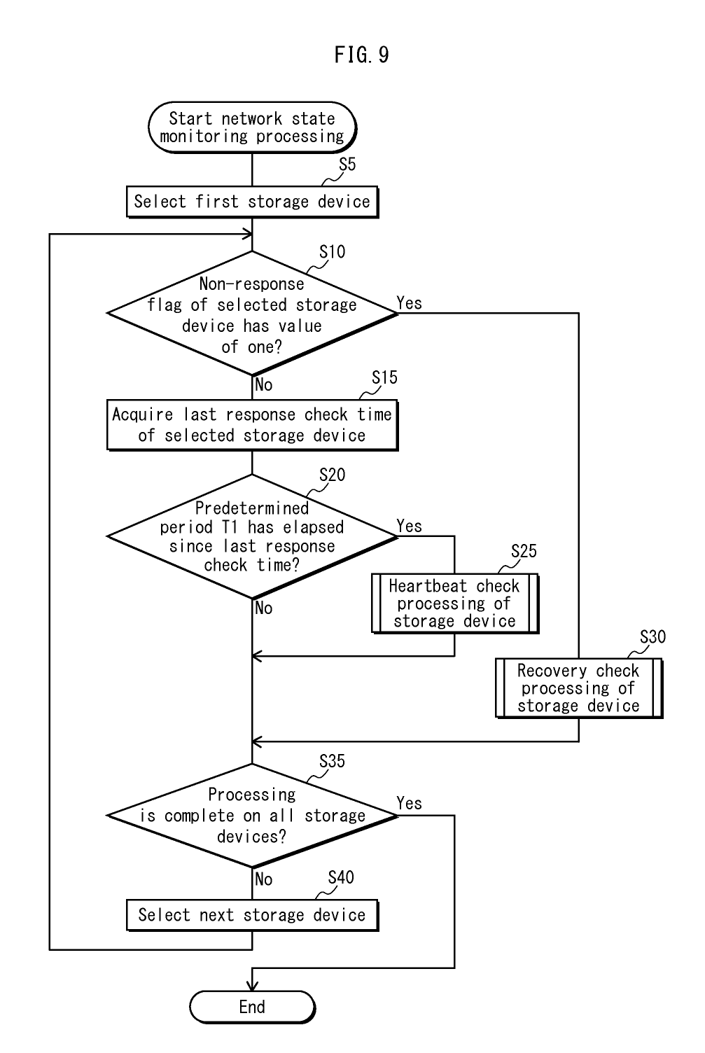

(1) Network State Monitoring Processing Firstly, description is given on network state monitoring processing of performing heartbeat check on each of the storage devices 11-15 at regular intervals such as every two seconds, with reference to a flow chart in FIG. 9.

The array state monitoring unit 104 selects one of the storage devices that is a target for monitoring (Step S5).

The array state monitoring unit 104 judges whether the selected storage device is non-responding, by judging whether a non-response flag corresponding to the selected storage device has a value of one with use of the network state management table T100 (Step S10).

If judging that the non-response flag has a value of one, that is, the selected storage device is non-responding (Step S10: Yes), the array state monitoring unit 104 executes recovery check processing on the selected storage device (Step S30).

If judging that the non-response flag does not have a value of one and has a value of zero, that is, the selected storage device is responding (Step S10: No), the array state monitoring unit 104 acquires the last response check time corresponding to the selected storage device with use of the network state management table T100 (Step S15). Then, the array state monitoring unit 104 judges whether a predetermined period T1 such as two seconds has elapsed from the acquired last response check time to the present time (Step S20).

If judging that the predetermined period T1 has elapsed from the last response check time to the present time (Step S20: Yes), the array state monitoring unit 104 executes heartbeat check processing on the selected storage device (Step S25).

If judging that the predetermined period T1 has not yet elapsed from the last response check time to the present time (Step S20: No), or after executing processing of Steps S25 or S35, the array state monitoring unit 104 judges whether processing is complete on all the storage devices that are targets for management, in other words, whether all the storage devices have been already selected (Step S35).

If judging that processing is not yet complete on all the storage devices (Step S35: No), the array state monitoring unit 104 selects a next storage device (Step S40), and the processing returns to Step S10.

If judging that processing is complete on all the storage devices (Step S35: Yes), the processing ends.

(2) Heartbeat Check Processing on Storage Device

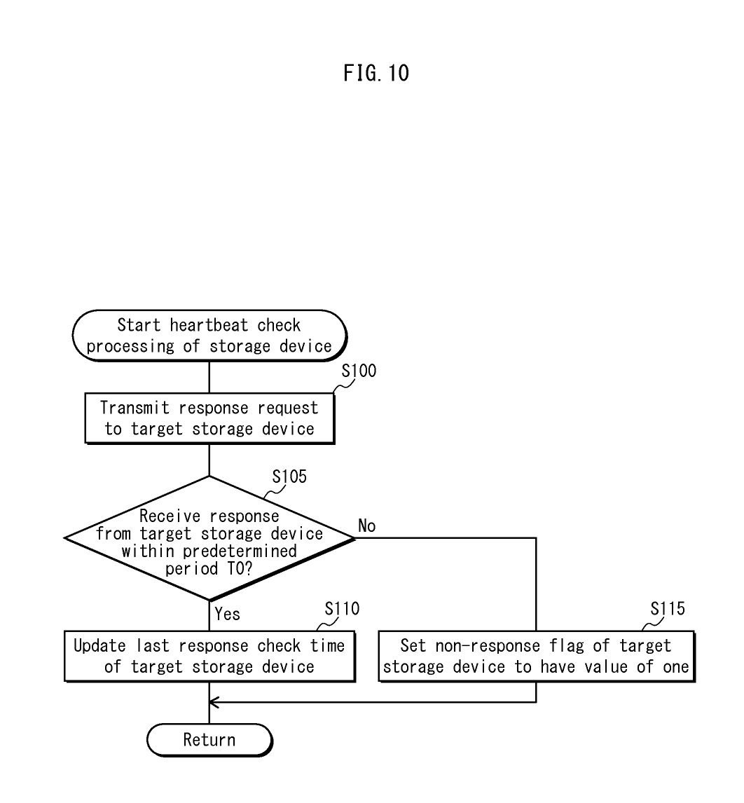

Here, description is given on processing of Step S25 shown in FIG. 9, with reference to a flow chart in FIG. 10.

The network state monitoring unit 101 transmits a response request to a storage device that is a target for heartbeat check (Step S100).

The network state monitoring unit 101 judges whether a response has been received from the target storage device within the predetermined period T0 (Step S105).

If judging that a response has been received (Step S105: Yes), the network state monitoring unit 101 notifies the array state monitoring unit 104 of response check information. The array state monitoring unit 104 updates the last response check time corresponding to the target storage device included in the network state management table T100 with the present time (Step S110).

If judging that no response has been received (Step S105: No), the network state monitoring unit 101 notifies the array state monitoring unit 104 of non-response information. Upon receiving the non-response information from the network state monitoring unit 101, the array state monitoring unit 104 sets the non-response flag corresponding to the target storage device included in the network state management table T100 to have a value of one (Step S115).

(3) Processing of Checking Recovery on Storage Device

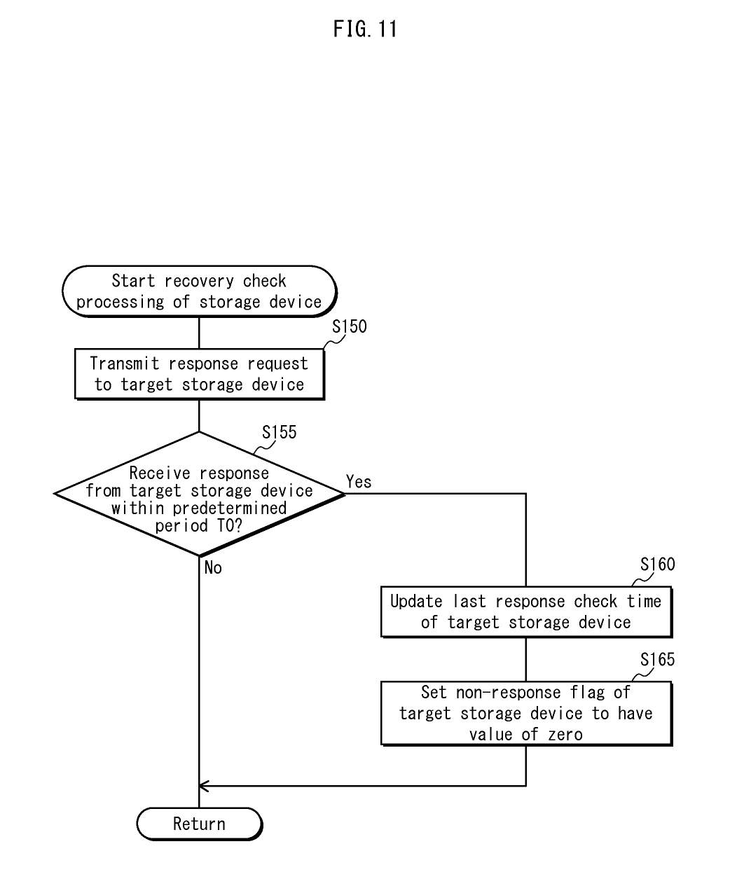

Here, description is given on processing of Step S30 shown in FIG. 9, with reference to a flow chart in FIG. 11.

The network state monitoring unit 101 transmits a response request to a storage device that is a target for recovery check processing (Step S150).

The network state monitoring unit 101 judges whether a response has been received from the target storage device within the predetermined period T0 (Step S155).

If judging that a response has been received (Step S155: Yes), the network state monitoring unit 101 notifies the array state monitoring unit 104 of response check information. The array state monitoring unit 104 updates the last response check time corresponding to the target storage device included in the network state management table T100 with the present time (Step S160).

The array state monitoring unit 104 sets the non-response flag corresponding to the target storage device included in the network state management table T100 to have a value of zero (Step S165).

(4) Processing of Determining Redundancy Policy at Non-response of Storage Device

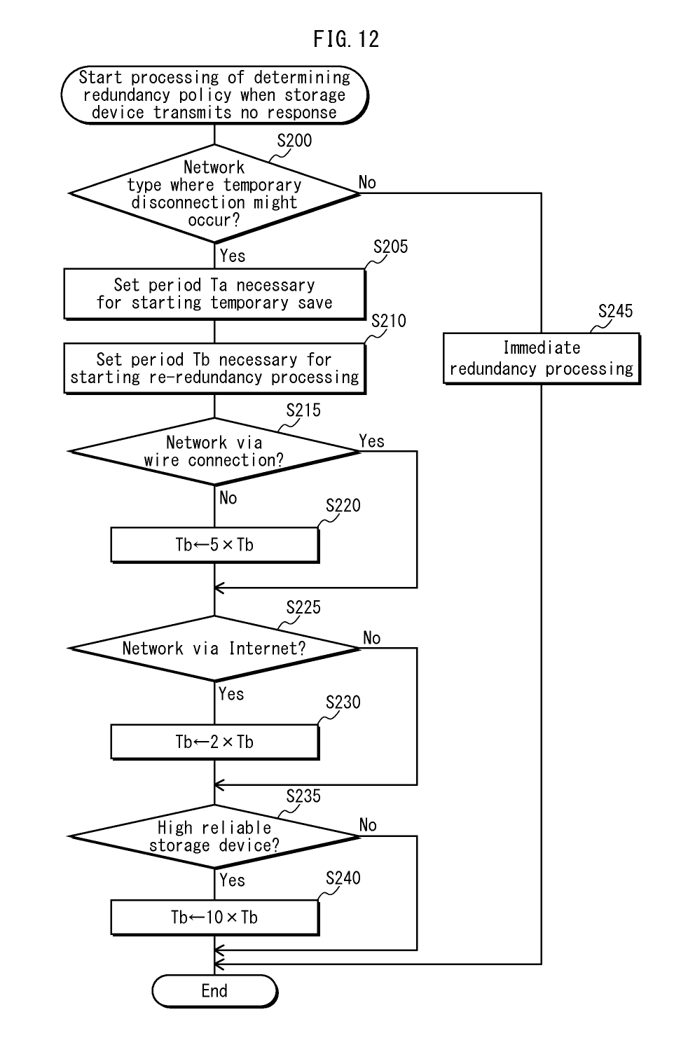

Here, description is given on processing of determining a redundancy policy at non-response of a storage device, which is executed by the redundancy policy determination unit 105, with reference to a flow chart in FIG. 12.

The redundancy policy determination unit 105 judges whether a network type of a non-responding storage device indicates that temporary shutdown might occur, with use of the network type included in the network state management table T100 (Step S200). Here, a network type indicating that temporary shutdown cannot occur means, for example, connection via an SCSI, connection via an USB, and the like.

If judging that the network type of the non-responding storage device indicates that temporary shutdown might occur (Step S200: Yes), the redundancy policy determination unit 105 sets a period Ta necessary for starting temporary save for preventing overflow in the cache (Step S205). The period Ta is, for example, five seconds.

The redundancy policy determination unit 105 sets a period Tb, as the initial value, necessary for judging that re-redundancy processing is to be executed (Step S210). The period Tb is, for example, ten seconds.

The redundancy policy determination unit 105 judges whether the network connected with the non-responding storage device is wired-connected, with use of the network type included in the network state management table T100 (Step S215).

If judging that the connected network is not wired-connected, that is, the connected network is wireless-connected (Step S215: No), the redundancy policy determination unit 105 resets the period Tb to 5×Tb (Step S220).

After performing Step S220, or if judging that the network connected with the non-responding storage device is network via wired connection (Step S215: Yes), the redundancy policy determination unit 105 further judges whether the network connected with the non-responding storage device is network via the Internet (Step S225).

If judging that the connected network is network via the Internet (Step S225: Yes), the redundancy policy determination unit 105 resets the period Tb to 2×Tb (Step S230).

After performing Step S230, or if judging that the network connected with the non-responding storage device is network via the Internet (Step S225: Yes), the redundancy policy determination unit 105 further judges whether the non-responding storage device is a high reliable storage device, with use of the storage type included in the storage state management table T200 (Step S225).

If judging that the non-responding storage device is a high reliable storage device (Step S235: Yes), the redundancy policy determination unit 105 resets the period Tb to 10×Tb (Step S240).

If judging that the network type of the non-responding storage device indicates that temporary shutdown cannot occur (Step S200: No), the redundancy policy determination unit 105 notifies the array state monitoring unit 104 of an instruction to immediately execute re-redundancy processing (Step S245).

(5) Processing of Determining Redundancy Policy at Recovery of Storage Device

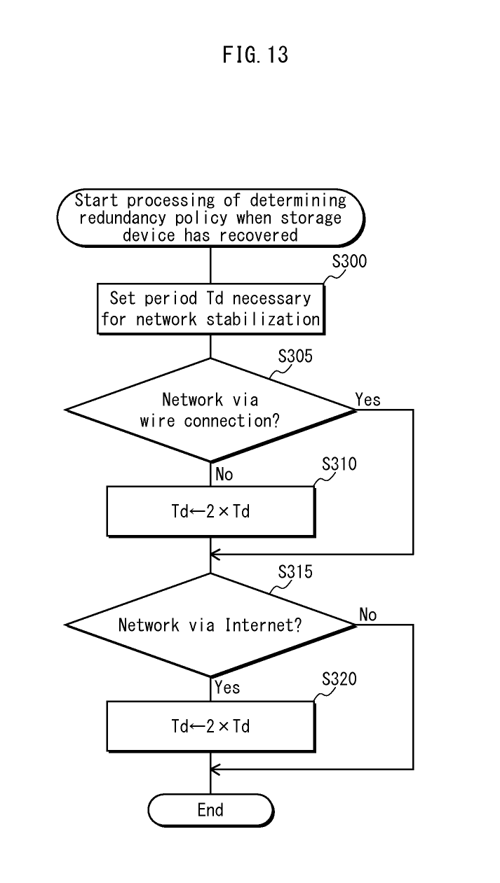

Here, description is given on processing of determining a redundancy policy at recovery of a storage device, executed by the redundancy policy determination unit 105, with reference to a flow chart in FIG. 13.

The redundancy policy determination unit 105 sets a period Td, as the initial value, necessary for the network state to become stabilized after recovery (Step S300).

The redundancy policy determination unit 105 judges whether the network connected with the non-responding storage device is network via wired connection, with use of the network type included in the network state management table T100 (Step S305).

If judging that the network connected with the non-responding storage device is not network via wired connection, that is, the connected network is network via wireless connection (Step S305: No), the redundancy policy determination unit 105 resets the period Td to 2×Td (Step S310).

After performing Step S310, or if judging that the network connected with the non-responding storage device is network via wired connection (Step S305: Yes), the redundancy policy determination unit 105 further judges whether the connected network is network via the Internet (Step S315).

If judging that the connected network is network via the Internet (Step S315: Yes), the redundancy policy determination unit 105 resets the period Td to 2×Td (Step S320).

(6) Access Processing in Normal State

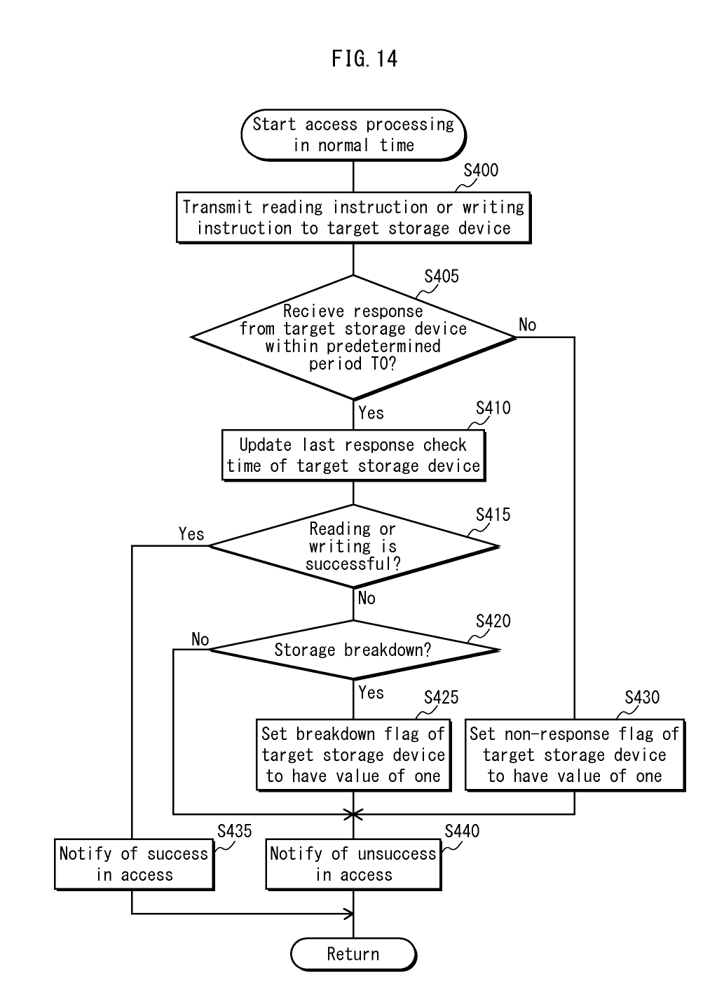

Here, description is given on processing of accessing (reading or writing) data in the normal state, with reference to a flow chart in FIG. 14.

When reading or writing data from or to each of the storage devices in accordance with an instruction issued by the external device, which is received from the request reception unit 107, the data processing execution unit 111 transmits a reading instruction or a writing instruction to a target storage device (Step S400).

The data processing execution unit 111 judges whether a response has been received from the target storage device within the predetermined period T0 (Step S405). If judging that the response has been received (Step S405: Yes), the array state monitoring unit 104 updates the last response check time corresponding to the target storage device included in the network state management table T100 with the present time (Step S410).

The data processing execution unit 111 reads or writes data, and judges whether reading or writing has succeeded (Step S415). If judging that reading or writing has succeeded (Step S415: Yes), the data processing execution unit 111 notifies the external device of success in access (Step S435).

If judging that reading or writing has failed (Step S415: No), the storage state monitoring unit 102 further judges whether the target storage device has broken down based on results of monitoring on the storage state of the target storage device performed by the storage state monitoring unit 102 (Step S420). If judging that the target storage device has broken down (Step S420: Yes), the array state monitoring unit 104 sets the breakdown flag corresponding to the target storage device included in the storage state management table T200 to have a value of one (Step S425).

Also, if judging that no response has been received from the target storage device within the predetermined period T0 (Step S405: No), the array state monitoring unit 104 sets the non-response flag corresponding to the target storage device included in the network state management table T100 to have a value of one (Step S430).

After performing Step S425, after performing Step S430, or if judging that the target storage device has not broken down (Step S420: No), the data processing execution unit 111 notifies the external device of unsuccess in access (Step S440).

(7) Writing Processing at Occurrence of Network Failure

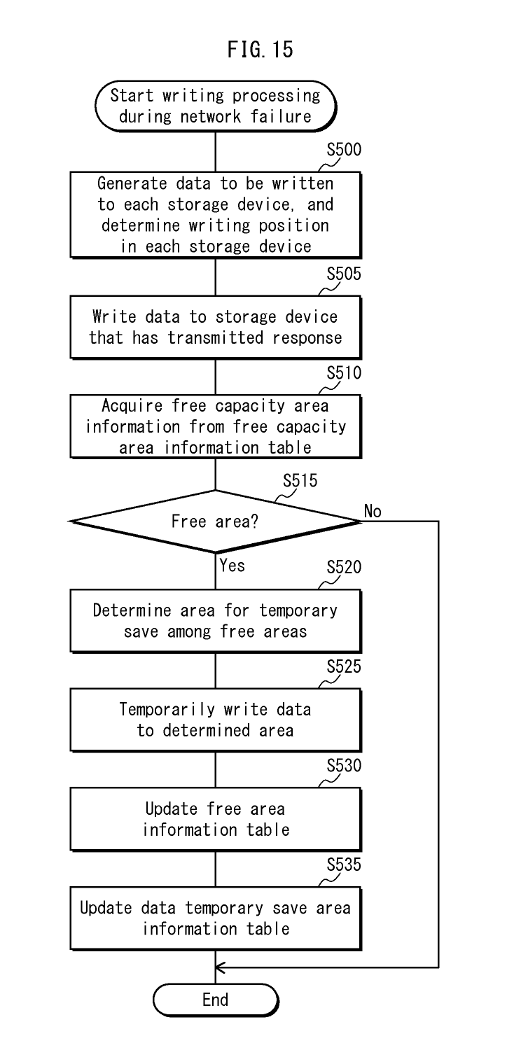

Here, description is given on processing of writing data performed at occurrence of network failure, with reference to a flow chart in FIG. 15.

Upon receiving a data writing request and target data from the request reception unit 107, the data processing execution unit 111 determines a writing position of the data to be written to each of the storage devices (Step S500). The writing position of the data to be written to each of the storage devices is determined by an algorithm compliant with the RAID method.

The data processing execution unit 111 writes the data to the determined writing position in a storage device in which no network failure occurs, in other words, a storage device that is responding (Step S505).

The data processing execution unit 111 acquires a free capacity from each of all the storage devices in which no network failure occurs among the storage devices managed by the free area information table T400 (Step S510).

The data processing execution unit 111 judges whether there is any free area for temporarily saving the data to be written originally to a storage device in which network failure occurs, that is, there is any storage device that can temporarily save the data to be written to the storage device in which the network failure occurs (Step S515).

If judging that there is any storage device that can temporarily save the data (Step S515: Yes), the data processing execution unit 111 selects one storage device that can temporarily save the data, and determines an area for temporary save among free areas of the selected storage device (Step S520). Then, the data processing execution unit 111 writes, to the determined area, the data to be written in the network failure occurs (Step S525).

The data processing execution unit 111 updates the free area information table T400, with respect to the free capacity of the storage device in which the data is temporarily saved.

The data processing execution unit 111 updates the data temporary save area information table T500, with use of the storage number identifying the storage device in which the network failure occurs, the writing position of the data determined at reception of the data, the size of the data to be written, the storage number identifying the storage device that is the temporary save destination, and the writing position of the data in the storage device that is the temporary save destination (Step S535). Specifically, the data processing execution unit 111 writes the storage number identifying the storage device in which the network failure occurs, the writing position of the data determined at reception of the data, the size of the data to be written, the storage number identifying the storage device that is the temporary save destination, and the writing position of the data in the storage device that is the temporary save destination, to the non-responding storage number, the writing offset, the writing size, the temporary save storage number, and the temporary save offset, respectively, which are included in the data temporary save area information table T500.

(8) Reading Processing at Occurrence of Network Failure

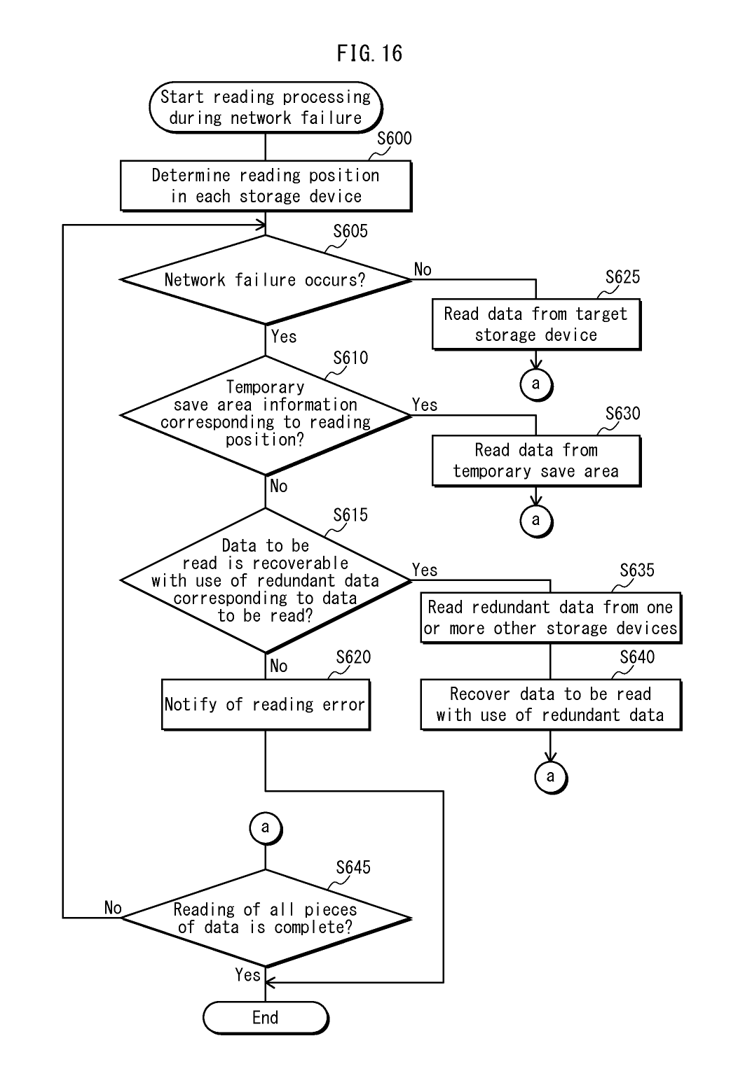

Here, description is given on processing of reading data at occurrence of network failure, with reference to a flow chart in FIG. 16.

Upon receiving a data reading request from the request reception unit 107, the data processing execution unit 111 determines a reading position of the data to be read from each of the storage devices (Step S600). The reading position of the data to be read from each of the storage devices is determined by an algorithm compliant with the RAID method.

The data processing execution unit 111 judges whether network failure occurs in each of the storage devices, with use of the network failure management table T300 (Step S605).

If judging that network failure occurs in a given storage device (Step S605: Yes), the data processing execution unit 111 further judges whether the data temporary save area information table T500 includes any temporary save area information corresponding to a reading position in the storage device in which the network failure occurs (Step S610).

If judging that the data temporary save area information table T500 does not include the corresponding temporary save area information (Step S610: No), the data processing execution unit 111 further judges whether the data to be read is recoverable with use of redundant data (Step S615). Specifically, the data processing execution unit 111 judges whether there are a number of normal storage devices necessary for recovering the data, by an algorithm compliant with the RAID method.

If judging that the data is unrecoverable (Step S615: No), the data processing execution unit 111 notifies the request reception unit 107 of a reading error (Step S620).

If judging that no network failure occurs in each of the storage devices (Step S605: No), the data processing execution unit 111 reads the data from the determined reading position in each of the storage devices (Step S625).

If judging that the data temporary save area information table T500 includes any temporary save area information corresponding to the reading position in the storage device in which the network failure occurs (Step S610: Yes), the data processing execution unit 111 reads the data to be read from the storage device in which the network failure occurs, from one or more other storage devices that are temporary save destinations indicated by the temporary save area information (Step S630). With respect to a storage device in which no network failure occurs, the data processing execution unit 111 reads the data from the determined reading position in the storage device.

If judging that the data to be read is recoverable with use of the redundant data (Step S615: Yes), the data processing execution unit 111 acquires the redundant data from one or more other storage devices (Step S635), and recovers the data to be read from the storage device in which the network failure occurs, with use of the acquired redundant data (Step S640). With respect to a storage device in which no network failure occurs, the data processing execution unit 111 reads the data from the determined reading position in the storage device.

After performing Step S625, after performing Step S630, or after performing Step S640, the data processing execution unit 111 judges whether reading of all the pieces of data is complete (Step S645). This judgment is made based on whether any piece of data remains in the cache, for example.

If the data processing execution unit 111 judges that reading of all the pieces of data is not yet complete (Step S645: No), the processing returns to Step S605.

(9) Processing of Recovering from Network Failure

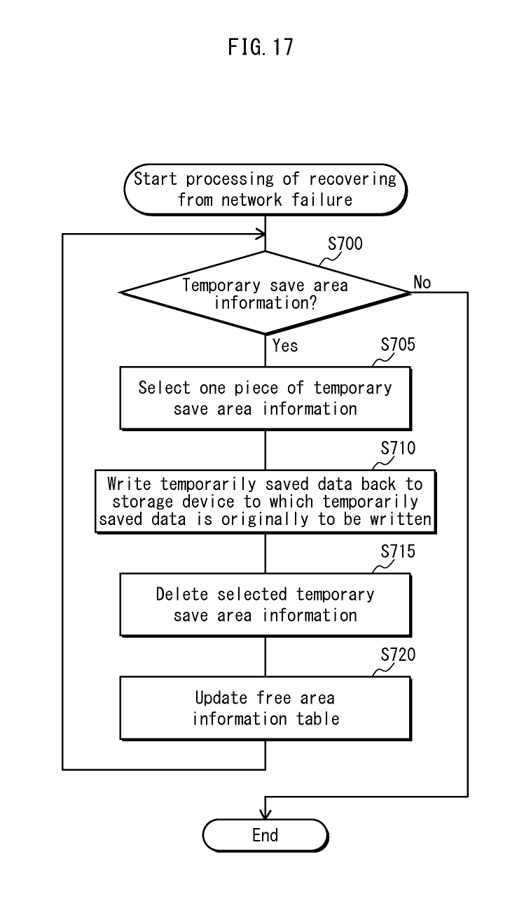

Here, description is given on processing of recovering from network failure, with reference to a flow chart in FIG. 17.

Upon receiving recovery information from the array state monitoring unit 104, the recovery processing execution unit 112 judges whether the data temporary save area information table T500 includes any temporary save area information (Step S700).

If judging that the data temporary save area information table T500 includes any temporary save area information (Step S700: Yes), the recovery processing execution unit 112 selects one piece of temporary save area information (Step S705).

With use of the selected temporary save area information, the recovery processing execution unit 112 writes data, which has been temporarily written, to back to a storage device to which the data is originally to be written (Step S710). Specifically, the recovery processing execution unit 112 specifies a storage device that is a temporary save destination, and a start position and an end position in the temporary save destination, based on the temporary save storage number, the temporary save offset, and the writing size that are included in the selected temporary save area information. The recovery processing execution unit 112 writes, to a position indicated by the writing offset in a storage device identified by the non-responding storage number included in the selected temporary save area information, data which has been written to a range from the start position to the end position in the storage device that is the specified temporary save destination.

The recovery processing execution unit 112 deletes the selected temporary save area information from the data temporary save area information table T500 (Step S715). Also, the recovery processing execution unit 112 updates the free capacity included in the free area information table T400 (Step S720), and the processing returns to Step S700.

(10) Entire Operations Performed at Non-response of Storage Device

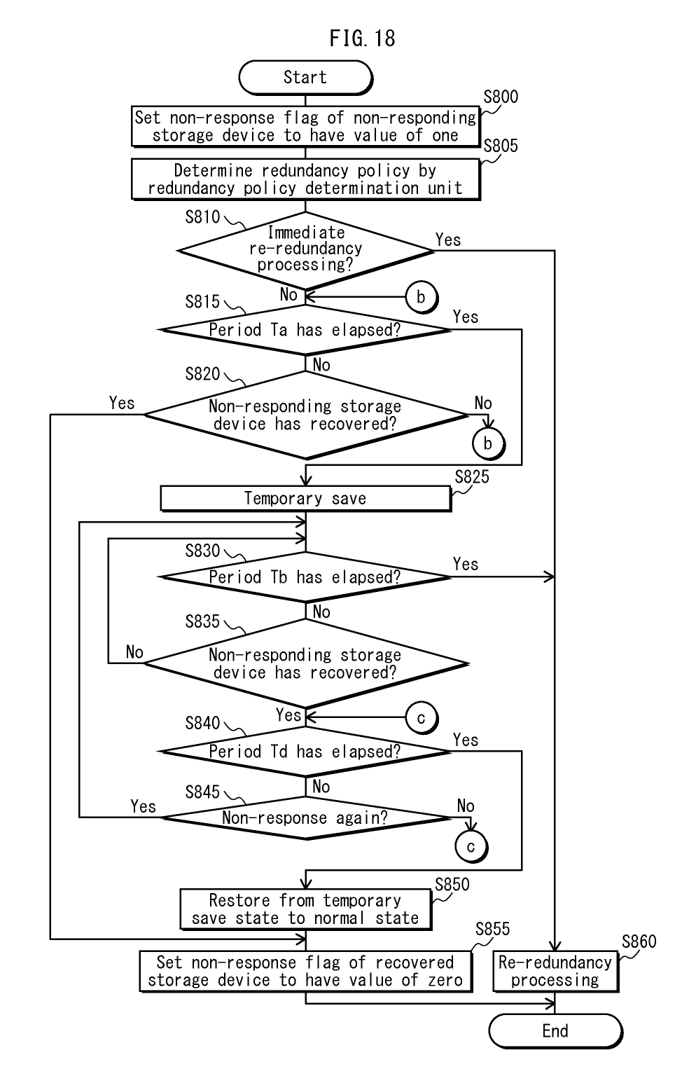

Here, description is given on the outline of the entire operations of the array management device 100 in the case where a storage device is non-responding, with reference to a flow chart in FIG. 18.

The array state monitoring unit 104 sets the non-response flag corresponding to a non-responding storage device included in the network state management table T100 to have a value of one (Step S800).

The redundancy policy determination unit 105 executes the processing of determining redundancy policy at non-response corresponding to a storage device, which is shown in FIG. 12, thereby to set periods Ta and Tb in accordance with the network type of the non-responding storage device (Step S805).

The array state monitoring unit 104 judges whether re-redundancy processing is to be immediately executed, based on results of the processing of determining redundancy policy at non-response of a storage device (Step S810).

If judging that re-redundancy processing is not to be executed (Step S810: No), the array state monitoring unit 104 further judges whether the period Ta set by the redundancy policy determination unit 105 has elapsed (Step S815).

If judging that the period Ta has not yet elapsed (Step S815: No), the array state monitoring unit 104 further judges whether the non-responding storage device has recovered, that is, whether response check information of the non-responding storage device has been received from the network state monitoring unit 101 (Step S820).

If judging that the non-responding storage device has not yet recovered (Step S820: No), the processing returns to Step S815, and the array state monitoring unit 104 continues to count time until the period Ta has elapsed.

If judging that the period Ta has elapsed (Step S815: Yes), the array state monitoring unit 104 temporarily saves the data to be written (Step S825). Also, the array state monitoring unit 104 writes the storage number identifying the storage device in which network failure occurs, a time at when network failure is judged to have occurred, the period Tb calculated by the redundancy policy determination unit 105, to the storage number, the network failure occurrence time, and the check period Tb, respectively, which are included in the network failure management table T300.

The array state monitoring unit 104 judges whether the period Tb set by the redundancy policy determination unit 105 has elapsed, while performing the temporary save (Step S830).

If judging that the period Tb has not yet elapsed (Step S830: No), the array state monitoring unit 104 further judges whether a response has been received from the non-responding storage device, in other words, whether response check information of the non-responding storage device has been received from the network state monitoring unit 101 (Step S835).

If judging that a response has not yet been received from the non-responding storage device (Step S835: No), the processing returns to Step S830, and the array state monitoring unit 104 continues to count time until the period Tb has elapsed.

If judging that a response has been received from the non-responding storage device (Step S835: Yes), the redundancy policy determination unit 105 sets a period Td in accordance with the network type corresponding to the storage device which has recovered. The array state monitoring unit 104 judges whether the period Td set by the redundancy policy determination unit 105 has elapsed (Step S840).

If judging that the period Td has not yet elapsed (Step S840: No), the array state monitoring unit 104 further judges whether the storage device, which has recovered, has now again become non-responding (Step S845).

If judging that the storage device, which has recovered, has now again become non-responding (Step S845: Yes), the processing returns to Step S830, and the array state monitoring unit 104 restarts measuring time until the period Td has elapsed to judge whether the period Tb has elapsed.

If judging that the storage device, which has recovered, is responding (Step S845: No), the processing returns to Step S840, and the array state monitoring unit 104 continues to count time until the period Td has elapsed.

If judging that the period Td has elapsed (Step S840: Yes), the array state monitoring unit 104 restores from the temporary save state in which data is temporarily saved to the normal state (Step S850). Specifically, the array state monitoring unit 104 notifies the processing unit 106 of recovery information indicating recovery from the network failure, and deletes the network failure information corresponding to the recovered storage device from the network failure management table T300. Furthermore, the array state monitoring unit 104 updates the network state management table T100, that is, sets the non-response flag corresponding to the recovered storage device included in the network state management table T100 to have a value of zero. Also, the recovery processing execution unit 112 executes recovery processing shown in FIG. 17 to write data back, delete the data from the temporary save area, and update the free area information table T400.

Also, after performing Step S850, or if judging that the non-responding storage device has recovered (Step S820: Yes), the array state monitoring unit 104 sets the non-response flag corresponding to the recovered storage device to have a value of zero (Step S855).

If judging that re-redundancy processing is to be immediately executed (Step S810: Yes), or if judging that the period Tb has elapsed (Step S830: Yes), the redundancy execution unit 110 executes re-redundancy processing (Step S860).

1.5 State Shift

Here, description is given on shift of redundancy state.

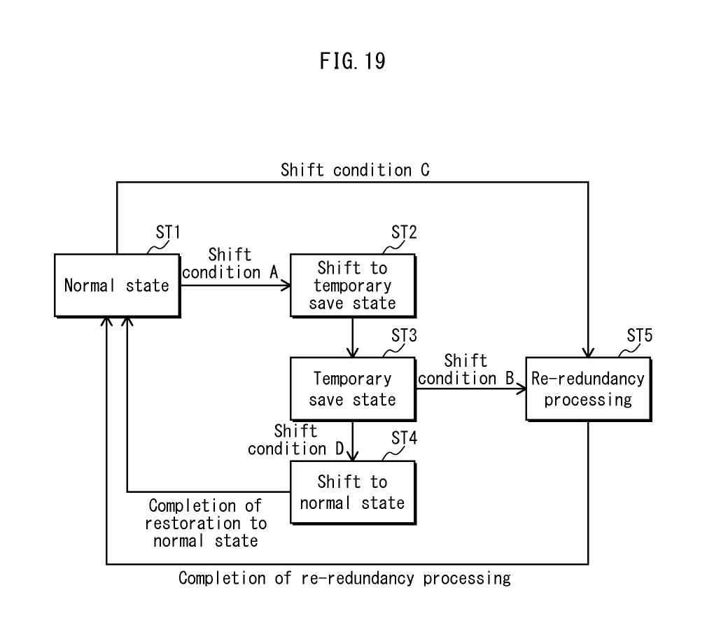

FIG. 19 shows the state shift until execution of redundancy processing.

While no failure occurs, the array management system 1 operates in the normal state (ST1).

In the normal state, when detecting a non-responding storage device (the storage device 11 here), the array management device 100 waits for elapse of a period Ta as a period necessary for recovery. If the array management device 100 receives a response from the storage device 11 within the period Ta, the array management system 1 maintains in the normal state. If the array management device 100 does not receive a response from the storage device 11 within the period Ta, that is, if shift condition A is met, the array management device 100 judges that network failure occurs in the storage device 11, and executes shift processing of shifting to the temporary save state for preventing overflow in the cache (ST2). Here, the shift processing to the temporary save state is performed by calculating a check period Tb and writing the storage number identifying the storage device in which the network failure occurs, a network failure occurrence time, and the check period Tb to the network failure management table T300.

After the shift processing is complete, the array management system 1 shifts to the temporary save state (ST3). When a writing instruction of data is issued in the temporary save state, the array management device 100 writes the data to one or more other storage devices having a free area enough to write the data, instead of writing the data to the storage device 11 in which the network failure occurs.

Then, if the array management device 100 receives a response from the storage device 11, and the storage device 11 does not become non-responding until the period Td has elapsed after check of the response, in other words, if shift condition D is met where heartbeat of the storage device 11 is confirmed within the period Td after check of the response, the array management device 100 judges that the storage device 11 has recovered from the network failure, and executes shift processing of shifting to the normal state (ST4). Here, the shift processing of shifting to the normal state is performed by writing the data that is temporally saved back to the storage device to which the data is originally to be written (the storage device 11 in which the network failure has occurred and now recovers), and updating the free area information table T400 and the data temporary save area information table T500.

After the shift processing of shifting to the normal state is complete, the array management system 1 restores to the normal state (ST1).

Also, if any failure occurs in the normal state in which automatic recovery is not expected such as storage breakdown and physical breakdown of network, that is, if condition C is satisfied, the array management device 100 immediately executes re-redundancy processing (ST5). After the re-redundancy processing is complete, the array management system 1 restores to the normal state in which the re-redundancy processing has been executed (ST1).

There is of course a case where the array management system 1 shifts from the normal state ST1 to a degraded state where temporary save and re-redundancy cannot be performed and the redundancy is degraded, or a data loss state where the array breaks down and data is lost. In such a case, however, the array management system 1 immediately shifts from the normal state ST1 to the state ST5.

1.6 Specific Examples

(1) Temporary Save

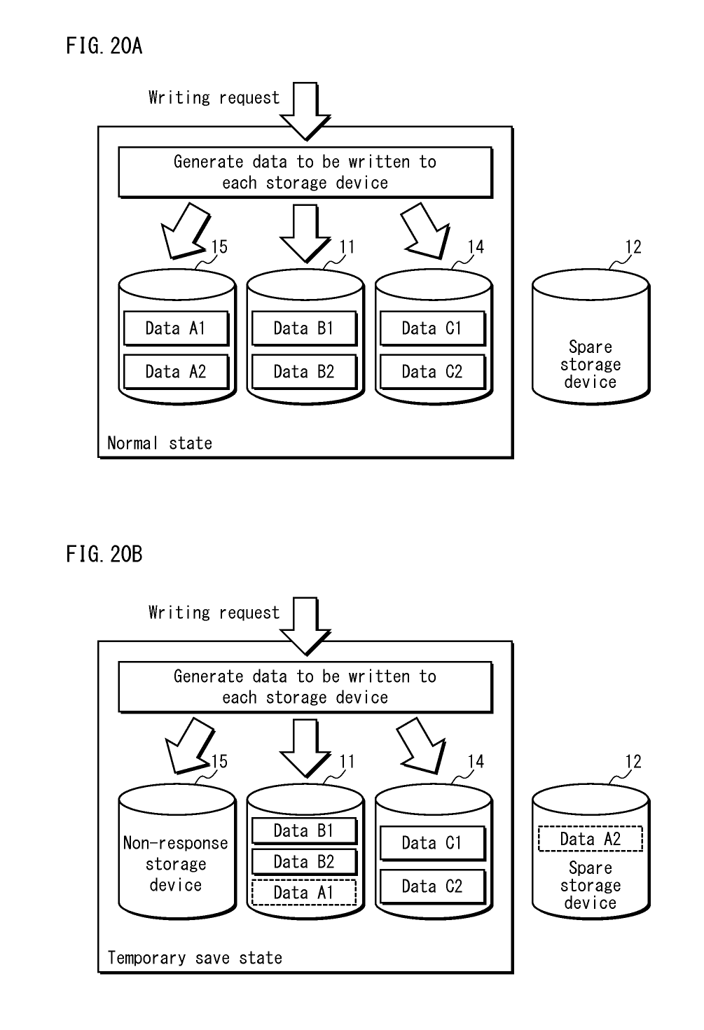

FIG. 20A is an image diagram showing data writing in the normal state. Upon receiving a writing request in the normal state, the array management device 100 determines respective pieces of data to be written to storage devices which configure redundancy (the storage devices 11, 14, and 15 here), and writes the respective pieces of data to the storage devices. For example, upon receiving a writing request of data X1, the array management device 100 generates data A1, data B1, and data C1, as data to be written. Upon receiving a writing request of data X2, the array management device 100 generates data A2, data B2, and data C2, as data to be written. Here, the data B1 is recoverable from the data A1 and the data C1, and the data A1 is recoverable from the data B1 and the data C1. The same applies to the data A2, the data B2, and the data C2 generated from the data X2. Specifically, the data B2 is recoverable from the data A2 and the data C2, and the data A2 is recoverable from the data B2 and the data C2.

Compared with this, FIG. 20B is an image diagram showing data writing performed at occurrence of network failure, that is, in the temporary save state. In the temporary save state, the array management device 100 determines respective pieces of data to be written to the storage devices 11, 14, and 15, in the same manner as in the normal state. However, the data, which is to be written to the non-responding storage device 15 (data A1 and data A2), is temporarily saved in a free area of one or more other storage devices (storage device 11 here), a free area of a spare storage device (storage device 12 here), or the like. When the storage device 15 recovers from the network failure, the array management device 100 writes the data, which is temporarily saved, to the storage device to which the data is originally to be written, and then deletes the temporarily saved data.

With respect to data reading, the array management device 100 reads respective pieces of data from the storage devices 11, 12, and 14 other than the non-responding storage device 15, thereby to recover data to be read.

(2) Re-redundancy Processing

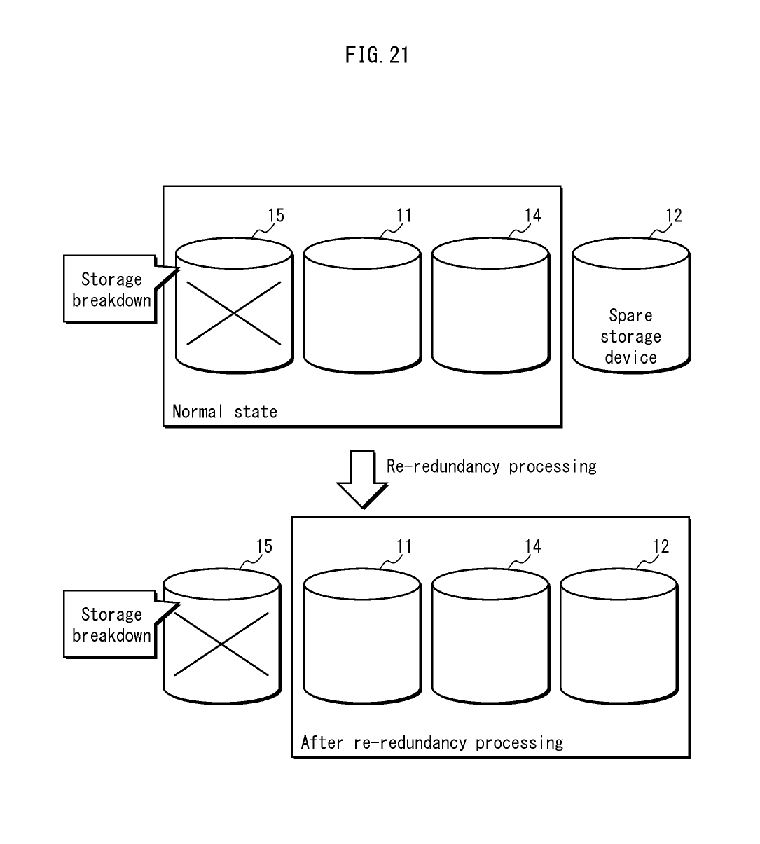

FIG. 21 is an image diagram showing re-redundancy processing.

Assume that, in the normal state, redundancy processing is executed on the storage devices 11, 14, and 15, and the storage device 15 has broken down.

In this case, the array management device 100 separates the storage device 15 from the redundancy configuration, and reconfigures redundancy on one or more other storage devices (the storage device 12 here, which is a spare storage device). Then, the array management device 100 recovers data saved in the storage device 15 with use of the storage devices 11 and 14, and writes the recovered data to the storage device 12, thereby to recover the array configuration.

1.7 Modification Examples

Although the present invention has been described based on the embodiment, the present invention is not limited to the embodiment. For example, the following modification examples may be included in the present invention.

(1) In the above embodiment, the respective values used for setting the periods Tb and Td so as to be longer than the initial values are just examples. Alternatively, a multiple number for setting the period Td so as to be longer the initial value may be a value greater than one.

(2) The wireless communication in the above embodiment means that a partial section on the shortest path to the network between the array management device and a storage device is a wireless section, or all the sections on the shortest path is wireless sections. Also, wired communication in the above embodiment means that there is no wireless section on the shortest path.

(3) In the above embodiment, the redundancy policy is determined when a storage device becomes non-responding, or when failure occurs in a storage device such as storage breakdown.

Alternatively, the array management device may hold beforehand therein a redundancy policy in accordance with the network type and the storage type.

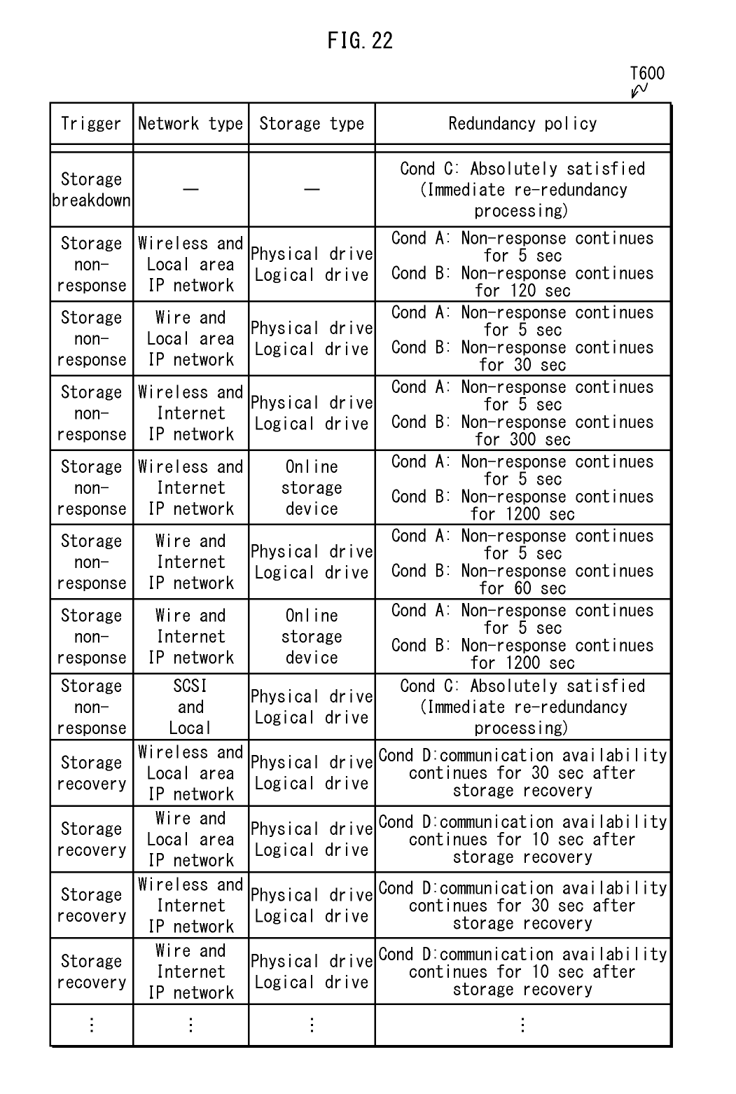

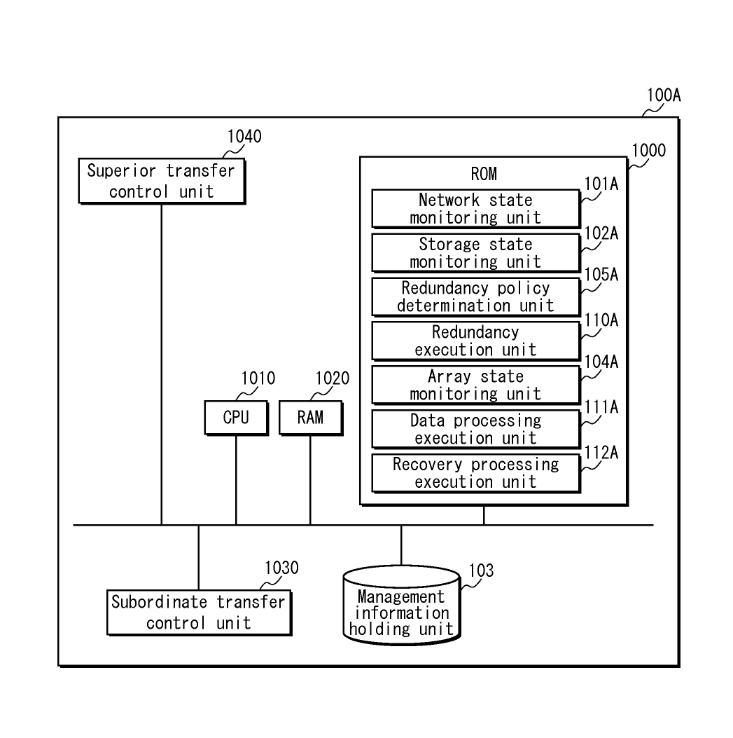

In this case, the array management device holds, in the management information holding unit, a policy determination table T600 such as shown in FIG. 22.

The policy determination table T600 has an area for holding a plurality of combinations each composed of a trigger, a network type, a storage type, and a redundancy policy.

The trigger indicates respective states monitored by the network state monitoring unit and the storage state monitoring unit.

The network type indicates the connection mode of network connected with each storage device.

The storage type indicates the type of configuration of each storage device.

The redundancy policy indicates conditions for determining a redundancy policy (here, for determining the periods Ta, Tb, and Td and for determining immediate execution of re-redundancy processing).

The redundancy policy is determined in accordance with a combination of the trigger, the network type, and the storage type.

For example, when a storage device is non-responding, the following shift conditions are determined in accordance with the network type and the storage type: shift condition A (for example, period Ta) for shifting from the normal state to the temporary save state; shift condition B (for example, period Tb) for shifting from the temporary save state to the re-redundancy state; or shift condition C for shifting from the normal state to the re-redundancy state.

Specifically, assume the case where a storage device is network-connected via a local area IP network, and a physical drive that is wireless-connected or wired-connected becomes non-responding without transmitting a response indicating occurrence of storage breakdown. This case is likely to occur due to network trouble, breakdown of the entire storage device including the transfer control unit, or the like. However, the array management device cannot certainly find the cause of the case. In such a situation, the array management device firstly estimates that the cause is network trouble, and performs temporary save. In the case where the storage device does not recover even after a predetermined period has elapsed since shift to the temporary save state, the array management device judges that storage breakdown has occurred, and executes re-redundancy processing. Here, the network stability differs between wired connection and wireless connection. Generally, wireless connection is lower in network stability than wired connection and is longer in period necessary for recovery than wired connection. In consideration of this, wireless connection is longer in predetermined period than wired connection.

In this way, it is possible to create and hold beforehand a redundancy policy determination table in accordance with the network state and the storage state. As the network state and the storage state, a power source state, user operation history information, and so on may be used for determining the periods Ta, Tb, and Td. By using the power source state in determination of the redundancy policy, it is possible to take into consideration network shutdown caused by battery runout. Also, by using the user operation history information, it is possible to take into consideration network shutdown caused by user's intentional operation of turning power OFF. As a result, it is possible to more appropriately determine a waiting period necessary for starting re-redundancy processing, thereby preventing unnecessary re-redundancy processing.

Also, in the above case, the redundancy policy determination unit specifies the network type and the storage type of a storage device that is a target for determining a redundancy policy, with use of the network state management table T100 and the storage state management table T200, respectively. The redundancy policy determination unit determines a redundancy policy, with use of the specified network type and storage type, and the policy determination table T600.

(4) In the above embodiment, in the case where IP network connection is used, a ping command or the like may be used for a method of transmitting a response request to a storage device and receiving a response from the storage device.

Also, irrespective of whether receiving a response request, each storage device may regularly transmit a response. Alternatively, upon automatically detecting re-connection with the network or the like, the storage device may transmit a response.

(5) In the above embodiment, the storage state acquisition unit 203 acquires the storage state indicating whether each storage device has broken down.

Alternatively, storage information stored in each storage device may be information acquirable from the storage state acquisition unit. The contents of storage information may differ for each storage device. For example, with respect to a storage device having a battery therein, the current power source state and the battery remaining amount may be stored as storage information. With respect to a storage device that receives user operations, user operation information and a user operation time may be stored as storage information. Also, information indicating whether each storage device is portable type may be stored as storage information. Further alternatively, each storage device may not store therein storage information.

(6) In the above embodiment, each storage device notifies of whether storage failure occurs by being regularly monitored by the storage state monitoring unit.

Alternatively, when storage information changes due to occurrence of storage breakdown or the like, the storage device may notify of occurrence of storage failure.

(7) In the above embodiment, part or all of the storage devices 11-15 may be housed in a housing of the digital recorder 10.

(8) The method described in the above embodiment may be realized by storing a program in which the procedure of the method is described in a memory, and reading and executing the program from the memory by a CPU (Central Processing Unit).

Alternatively, a recording medium having recorded therein the program in which the procedure of the method is described may be distributed.

Here, an example is given on the configuration where the above method is realized by program execution.

FIG. 23 shows an example of an array management device 100A having the configuration where the above method is realized by program execution.

The array management device 100A includes a ROM 1000 that records therein various types of processing programs, a CPU 1010 that controls the entire processing, a RAM 1020 that temporarily records therein data, a subordinate transfer control unit 1030 that controls data transfer with each storage device and management of the data transfer, a superior transfer control unit 1040 that controls data transfer with other device such as a digital camera and management of the data transfer, and a management information holding unit 103 that is a recording device. The network state monitoring unit 101, the storage state monitoring unit 102, the array state monitoring unit 104, the redundancy policy determination unit 105, the redundancy execution unit 110, the data processing execution unit 111, and the recovery processing execution unit 112, which have been described in the above embodiment, are stored in the ROM 1000 as programs for example, specifically as a network state monitoring unit 101A, a storage state monitoring unit 102A, an array state monitoring unit 104A, a redundancy policy determination unit 105A, a redundancy execution unit 110A, a data processing execution unit 111A, and a recovery processing execution unit 112A, respectively. Processing of the respective configuration elements is executed by the CPU 1010 executing the respective programs. The subordinate transfer control unit 1030 and the superior transfer control unit 1040 are equivalent to the communication unit 108 described in the above embodiment.

Also, the ROM 1000 may be an HDD or other recording device. Furthermore, the subordinate transfer control unit 1030 and the superior transfer control unit 1040 may share the same interface.

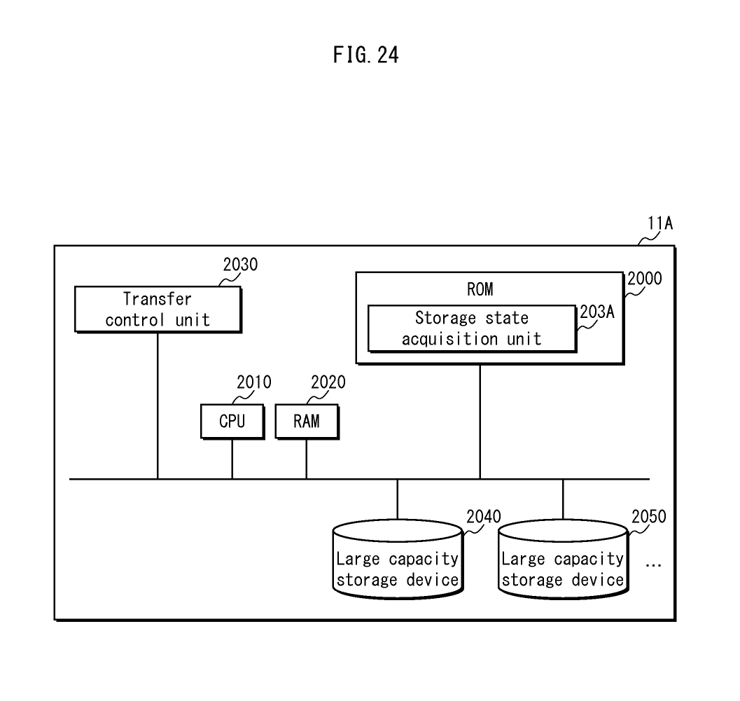

FIG. 24 shows an example of an array management device 100A having the configuration where the above method is realized by program execution.

The storage device 11A includes a ROM 2000, a CPU 2010, a RAM 2020, a transfer control unit 2030 that controls data transfer with an array management unit and management of the data transfer, and one or more large capacity recording devices 2040-2050. The large capacity recording devices 2040-2050 each may be an HDD or an SSD.

Also, the storage state acquisition unit 203 described in the above embodiment is saved in the ROM 2000 as a program such as a storage state acquisition unit 203A. Processing of the storage state acquisition unit 203 is executed by the CPU 2010 executing the program. Also, the transfer control unit 2030 is equivalent to the communication unit 204 described in the above embodiment. The large capacity recording devices 2040-2050 are equivalent to the holding unit 201 described in the above embodiment.

Also, the ROM 2000 may be an HDD or other recording device.

The storage devices each may have other system configuration. Specifically, the storage devices each may be a large capacity recording device, and be directly connected with the array management unit via a storage interface such as SCSI, and be controlled by the CPU of the array management device.

(9) The array management device described in the above embodiment is typically embodied as an LSI that is a semiconductor integrated circuit. The LSI may be separately integrated into a single chip, or integrated into a single chip including part or all of the functional blocks. The description is provided on the basis of an LSI here. Alternatively, the name of the integrated circuit may differ according to the degree of integration of the chips. Other integrated circuits include an IC, a system LSI, a super LSI, and an ultra LSI.

Furthermore, the method applied for forming integrated circuits is not limited to the LSI, and the present invention may be realized on a dedicated circuit or a general purpose processor. For example, the present invention may be realized on an FPGA (Field Programmable Gate Array) programmable after manufacturing LSIs, or a reconfigurable processor in which connection and settings of a circuit cell inside an LSI are reconfigurable after manufacturing LSIs.

Furthermore, when new technology for forming integrated circuits that replaces LSIs becomes available as a result of progress in semiconductor technology or semiconductor-derived technologies, functional blocks may be integrated using such technology. One possibility lies in adaptation of biotechnology.

In addition, the semiconductor chip formed by integrating the array management device described in the above embodiment may be combined with a display for rendering images so as to configure a rendering device applicable to various purposes. The present invention is utilizable in a portable phone, a TV, a digital video recorder, a digital video camera, a car navigation system, and so on. The present invention may be combined with a CRT (Cathode-Ray Tube) display, a liquid crystal display, a PDP (Plasma Display Panel), a flat display such as an organic EL display, a projection display as typified by a projector, and so on.

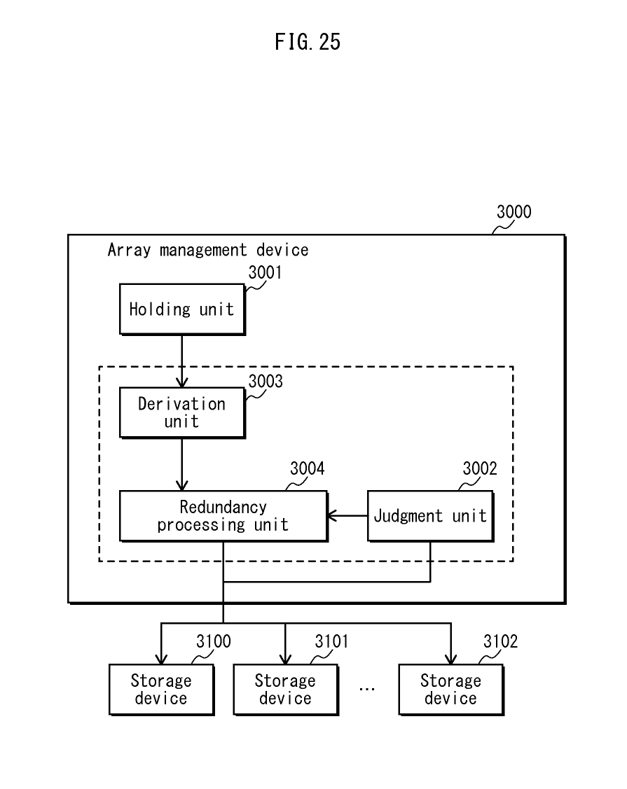

(10) An array management device 3000 relating to the present invention executes redundancy processing on a plurality of storage devices 3100, 3101, . . . , 3102, and controls access to each of the plurality of storage devices 3100, 3101, . . . , 3102. As shown in FIG. 25, the array management device 3000 may comprise: a holding unit 3001 configured to hold therein a configuration type of a communication path to each of the plurality of storage devices; a judgment unit 3002 configured to judge whether access to each of the plurality of storage devices has succeeded or failed; a derivation unit 3003 configured, with respect to each of the plurality of storage devices, to derive a waiting period in accordance with the configuration type held in the holding unit 3001, the waiting period being from when access to the storage device has failed to when execution of redundancy processing is to be started; and a redundancy processing unit 3004 configured, when the judgment unit 3002 judges that access to a given one of the plurality of storage devices has failed, and then does not judge that access to the given storage device has succeeded within the waiting period derived by the derivation unit 3003 in accordance with the configuration type of the communication path to the given storage device, to execute redundancy processing on the plurality of storage devices other than the given storage device.

In this case, the holding unit 3001, the judgment unit 3002, the derivation unit 3003, and the redundancy processing unit 3004 are realized by the management information holding unit 103, the combination of the network state monitoring unit 101 and the storage state monitoring unit 102, the redundancy policy determination unit 105, the combination of the array state monitoring unit 104 and the redundancy execution unit 110, which have been described in the above embodiment, respectively.

Also, the storages devices 3100, 3101, . . . , 3102 each correspond to any one of the storage devices 11-15 described in the above embodiment.

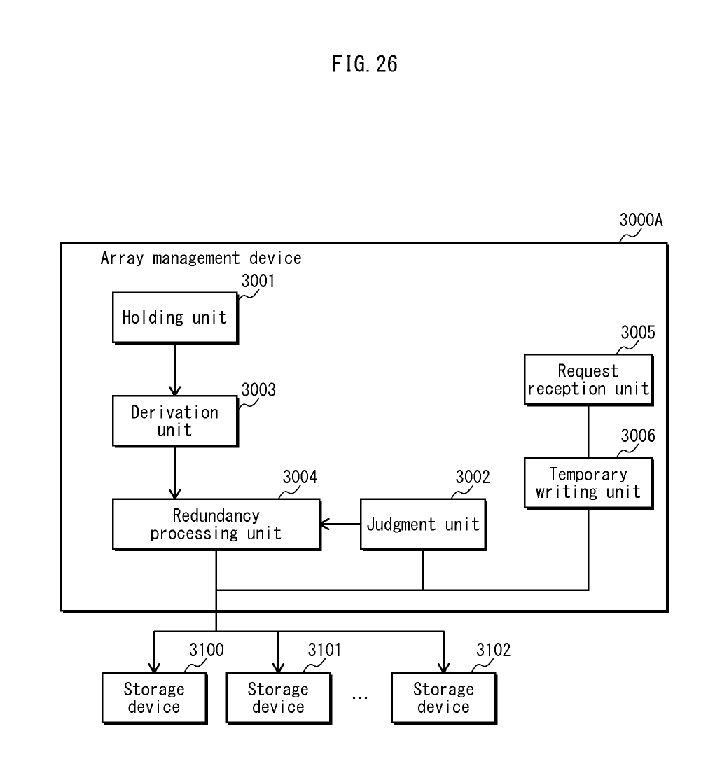

Also, an array management device 3000A relating to the present invention executes redundancy processing on a plurality of storage devices 3100, 3101, . . . , 3102, and controls access to each of the plurality of storage devices 3100, 3101, . . . , 3102. As shown in FIG. 26, the array management device 3000A may comprise: a holding unit 3001; a judgment unit 3002; a derivation unit 3003; a redundancy processing unit 3004; a request reception unit 3005 configured to receive an access request from an external device; and a temporary writing unit 3006 configured to write, to the plurality of storage devices other than a storage device to which access has failed, data that is to be written to the storage device to which access has failed.

In this case, the request reception unit 3005 is realized by the request reception unit 107 described in the above embodiment. The temporary writing unit 3006 is realized by the data processing execution unit 111 described in the above embodiment, particularly the functional operations performed at occurrence of network failure. Note that description is omitted here on the holding unit 3001, the judgment unit 3002, the derivation unit 3003, and the redundancy processing unit 3004 as already given above.

Alternatively, an integrated circuit that is included in an array management device, which comprises a holding unit configured to hold therein a configuration type of a communication path to each of the storage devices, executes redundancy processing on the plurality of storage devices, and controls access to each of the plurality of storage devices, may be configured from configuration elements (the judgment unit 3002, the derivation unit 3003, and the redundancy processing unit 3004) encircled by dashed lines in FIG. 25.

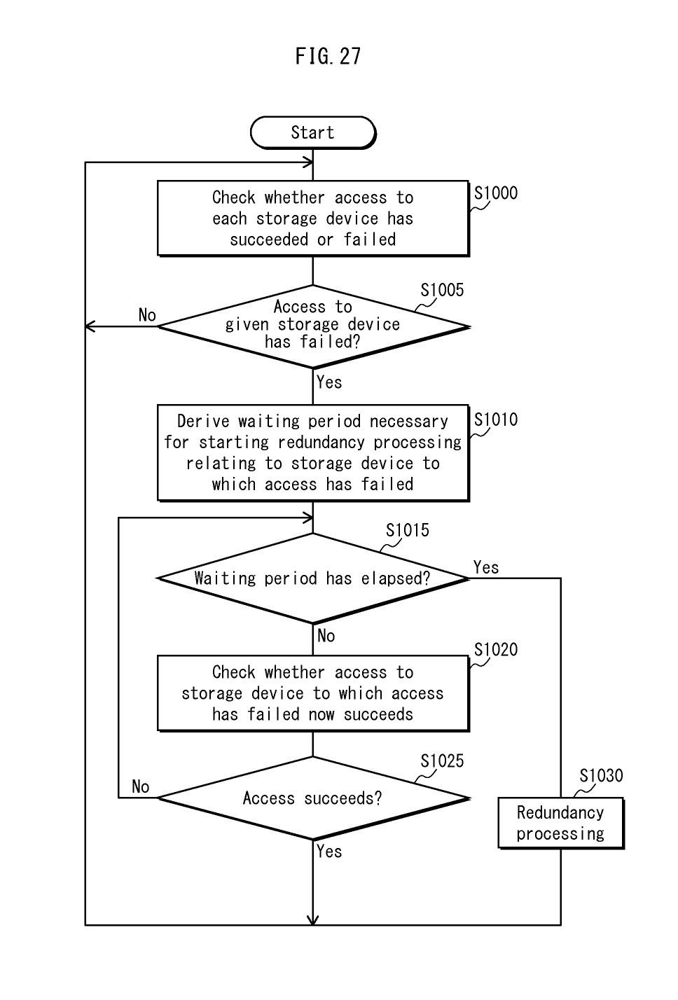

(11) The present invention provides an array management method for use in an array management device that comprises: a holding unit configured to hold therein a configuration type of a communication path to each of a plurality of storage devices; a judgment unit; a derivation unit; and a redundancy processing unit, and executes redundancy processing on the plurality of storage devices, and controls access to each of the plurality of storage devices. As shown in FIG. 27, the array management method may comprise: a check step of checking, by the judgment unit, whether access to each of the plurality of storage devices has succeeded or failed (Step S1000); a first judgment step of judging, by the judgment unit, whether the check step checks that access to a given one of the plurality of storage devices has failed (Step S1005); a derivation step of, when the first judgment step judges that the check step checks that access to the given storage device has failed, deriving, by the derivation unit, a waiting period for the given storage device in accordance with the configuration type of the communication path to the given storage device held in the holding unit, the waiting period being from when access to the given storage device has failed to when execution of redundancy processing is to be started (Step S1010); a second judgment step of, when the first judgment step judges that the check step checks that access to the given storage device has failed, judging, by the redundancy execution unit, whether the waiting period has elapsed that is derived in the derivation step in accordance with the configuration type of the communication path to the given storage device (Step S1015); and a redundancy execution step of, checking, by the judgment unit, whether access to the given storage device which has failed checked in the check step now succeeds or fails within the waiting period, (Step S1020), judging, by the judgment unit, whether the check step checks that access to the given storage device which has failed checked in the check step now succeeds (Step 1025), and when the judgment unit does not judge that the check step checks that access to the given storage device which has failed checked in the check step now succeeds, executing, by the redundancy processing unit, redundancy processing on the plurality of storage devices other than the given storage device (Step S1030).

In this case, the check step and the first judgment step are realized by the processing operations shown in FIG. 9, FIG. 10, and Step S835 in FIG. 18 described in the above embodiment. Also, the derivation step, the second judgment step, and the redundancy execution step are realized by the processing operations shown in FIG. 12, the processing operations shown in Step S830 in FIG. 18, and the processing operations shown in Step S860 in FIG. 18, which are described in the above embodiment, respectively.

(12) The above embodiment and any of the modification examples may be combined.

1.8 Supplementary Description

(1) An array management device that is one embodiment of the present invention is an array management device that executes redundancy processing on a plurality of storage devices, and controls access to each of the plurality of storage devices, the array management device comprising: a judgment unit configured to judge whether access to each of the plurality of storage devices has succeeded or failed; a holding unit configured to hold therein a configuration type of a communication path to each of the plurality of storage devices; a derivation unit configured, with respect to each of the plurality of storage devices, to derive a waiting period in accordance with the configuration type held in the holding unit, the waiting period being from when access to the storage device has failed to when execution of redundancy processing is to be started; and a redundancy processing unit configured, when the judgment unit judges that access to a given one of the plurality of storage devices has failed, and then does not judge that access to the given storage device has succeeded within the waiting period derived by the derivation unit in accordance with the configuration type of the communication path to the given storage device, to execute redundancy processing on the plurality of storage devices other than the given storage device.

With this configuration, the array management device derives the waiting period for necessary to start executing redundancy processing in accordance with the configuration type of the communication path of the storage device to which access has failed. Accordingly, the array management device can change the waiting period necessary for judging that re-redundancy processing is to be executed, that is, the criterion for judging to execute re-redundancy processing, in accordance with the configuration type of the communication path. As a result, when access succeeds within the waiting period, it is unnecessary to execute re-redundancy processing. Accordingly, the life-span of the storage device is longer compared with the case where re-redundancy processing is executed immediately after occurrence of failure.

(2) Here, the derivation unit may derive the waiting period so as to be longer when the configuration type indicates wireless communication than when the configuration type indicates wired communication.

With this configuration, when communication with a storage device to which access has failed is wireless-connected, the array management device derives a waiting period for the storage device so as to be longer than when the communication is wired-connected. Generally, wireless communication is lower in stability of communication establishment than wired communication. Accordingly, the reason why access has failed is likely temporary failure. For example, there is a case where communication cannot be established due to shutdown of the communication by any obstacle. In consideration of this, by setting the waiting period for wireless communication so as to be longer than for wired communication, automatic recovery from the temporary failure can be expected. Therefore, it is unnecessary to immediately execute re-redundancy processing.

(3) Here, the derivation unit may derive the waiting period so as to be longer when the configuration type indicates Internet communication than when the configuration type indicates LAN (Local Area Network) communication.

With this configuration, when network communication with a storage device to which access has failed is Internet communication, the array management device derives a waiting period for the storage device so as to be longer than when the communication is LAN communication. Generally, Internet communication is larger in data traffic amount than LAN communication, and accordingly it sometimes takes longer time to access a storage device via Internet communication than via LAN communication. Accordingly, the reason why access has hailed is likely temporary failure. For example, there is a case where it takes time to access the storage device due to a large traffic amount. In consideration of this, by setting the waiting period for Internet communication so as to be longer than for LAN communication, automatic recovery from the temporary failure can be expected.

(4) Here, with respect to the given storage device to which access has failed, when the configuration type of the communication path indicates communication that cannot be temporarily shut down, the redundancy processing unit may immediately execute redundancy processing on the plurality of storage devices other than the given storage device.

With this configuration, when communication with a storage device to which access has failed is communication that cannot be temporarily shut down, the array management device immediately executes re-redundancy processing. When access has failed to a storage device whose communication cannot be temporarily shut down, the reason why access has failed is likely physical failure such as breakdown of the storage device rather than temporary failure. In consideration of this, immediate execution of re-redundancy processing enables to make a prompt action.

(5) Here, the holding unit may further hold therein, with respect to each of the plurality of storage devices, information indicating whether the storage device protects data stored therein, and with respect to the given storage device to which access has failed, the derivation unit may derive the waiting period so as to be shorter when the information indicates that the given storage device does not protect data stored therein than when the information indicates that the given storage device protects data stored therein.

With this configuration, when a storage device to which access has failed protects data stored therein, the array management device derives a waiting period for the storage device so as to be longer than when the storage device does not protect data stored therein. Generally, a storage device that protects data stored therein has a lower probability of breakdown than a storage device that does not protect data stored therein. Accordingly, the reason why access to the storage device that protects data stored therein has failed is likely temporary failure. In consideration of this, by setting the waiting period for the case where the storage device protects data stored therein so as to be longer than the case where the storage device does not protect data stored therein, automatic recovery from the temporary failure can be expected.

(6) Here, the array management device may further comprise: a request reception unit configured to receive an access request from an external device; and a temporary writing unit configured to write, to each of the plurality of storage devices other than the given storage device to which access has failed, data to be written to the given storage device, wherein the request reception unit may receive a data writing request from the external device, and select one or more storage devices each to which data is to be written among the plurality of storage devices, and when the judgment unit judges that access to a given one of the one or more storage devices has failed, the redundancy processing unit may control the temporary writing unit to write the data within the waiting period derived by the derivation unit, and execute redundancy processing on the plurality of storage devices other than the given storage device after elapse of the waiting period.

With this configuration, within the waiting period, the array management device writes, data to be written to a storage device to which access has failed, to each of the plurality of storage devices other than the storage device to which access has failed. This prevents increase in amount of data that is not processed. For example, in the case where the data to be written is stored in a buffer, it is possible to prevent overflow in the buffer.

(7) Here, the judgment unit may include: a communication path state monitoring unit configured to monitor whether failure occurs in the communication path to each of the plurality of storage devices; and a storage state monitoring unit configured to monitor whether storage failure occurs in each of the plurality of storage devices, the communication path state monitoring unit may transmit a response request to each of the plurality of storage devices, and when receiving no response to the response request from a given one of the plurality of storage devices, the communication path state monitoring unit may judge that access to the given storage device has failed, and when breakdown as the storage failure occurs in a given one of the plurality of storage devices, the storage state monitoring unit may judge that access to the given storage device has failed.

With this configuration, the array management device can monitor whether failure occurs on the communication path and whether storage failure occurs by the communication path status monitoring unit and the storage status monitoring unit, respectively.

(8) Here, the holding unit may further hold therein, with respect to each of the plurality of storage devices: a non-response flag in correspondence with the configuration type of the communication path, the non-response flag indicating whether the response has been received; and a breakdown flag indicating whether breakdown occurs, when receiving no response from a given one of the plurality of storage devices, the communication path state monitoring unit may set the non-response flag of the given storage device to have a value indicating that no response has been received, when breakdown occurs in a given one of the plurality of storage devices, the storage state monitoring unit may set the breakdown flag of the given storage device to have a value indicating that breakdown occurs, the redundancy processing unit may include: an array state monitoring unit configured to monitor a state of an array configuration formed from a combination of the plurality of storage devices; and a redundancy execution unit configured to execute redundancy processing, and when the non-response flag of a given one of the plurality of storage devices has a value indicating that no response has been received, the array state monitoring unit may judge that redundancy processing is to be executed when no response is received from the given storage device within the waiting period derived by the derivation unit, and when the breakdown flag of a given one of the plurality of storage devices has a value indicating that breakdown occurs, the array state monitoring unit may judge that redundancy processing is immediately to be executed.

With this configuration, the array management device can easily judge whether failure occurs with use of the non-response flag and the breakdown flag.

(9) Here, the array management device may further comprise: a recovery processing unit configured to execute recovery processing when a given one of the plurality of storage devices to which access has failed recovers, the recovery processing being processing of writing, to the recovered storage device, data which has been written to other of the plurality of storage devices by the temporary writing unit, wherein when the non-response flag of a given one of the plurality of storage devices has a value indicating that no response has been received and then a response is received from the given storage device within the waiting period derived by the derivation unit, the array state monitoring unit may control the recovery processing unit to execute recovery processing.

With this configuration, after recovery from failure, the recovery processing execution unit writes data to a storage device to which the data is to be originally written. Accordingly, the array management device can easily manage data without executing re-redundancy processing.

### INDUSTRIAL APPLICABILITY

The array management device relating to the present invention is utilizable for a device that manages a large amount of data. For example, the array management device is highly valuable as a device that performs display by menu display or display by Web browser, editor, or EPG, in a battery-driven portable display terminal such as a portable phone, a portable music player, a digital camera, and a digital video camera, and a high-resolution information display device such as a TV, a digital video recorder, and a car navigation system.

### REFERENCE SIGNS LIST

1 array management system
2 Internet
10 digital recorder
11-15 and 11A storage device
100 and 100A array management device
101 and 101A network state monitoring unit
102 and 102A storage state monitoring unit
103 management information holding unit
104 and 104A array state monitoring unit
105 and 105A redundancy policy determination unit
106 processing unit
107 request reception unit
108 communication unit
110 and 110A redundancy execution unit
111 and 111A data processing execution unit
112 and 112A recovery processing execution unit
201 holding unit
202 processing unit
203 and 203A storage state acquisition unit
204 communication unit
1000 and 2000 ROM
1010 and 2010 CPU
1020 and 2020 RAM
1030 subordinate transfer control unit
1040 superior transfer control unit
2030 transfer control unit
2040 and 2050 large capacity storage device
3000 and 3000A array management device
3001 holding unit
3002 judgment unit
3003 derivation unit
3004 redundancy processing unit
3005 request reception unit
3006 temporary writing unit
3100, 3101, and 3102 storage device

1-11. (canceled)

12. An array management device that executes redundancy processing on a plurality of storage devices, and controls access to each of the plurality of storage devices, the array management device comprising:
a judgment unit configured to judge whether access to each of the plurality of storage devices has succeeded or failed;
a holding unit configured to hold therein a configuration type of a communication path to each of the plurality of storage devices;
a derivation unit configured, with respect to each of the plurality of storage devices, to derive a waiting period in accordance with the configuration type held in the holding unit, the waiting period being from when access to the storage device has failed to when execution of redundancy processing is to be started; and
a redundancy processing unit configured, when the judgment unit judges that access to a given one of the plurality of storage devices has failed, and then does not judge that access to the given storage device has succeeded within the waiting period derived by the derivation unit in accordance with the configuration type of the communication path to the given storage device, to execute redundancy processing on the plurality of storage devices other than the given storage device, wherein
the derivation unit derives the waiting period so as to be longer when the configuration type indicates wireless communication than when the configuration type indicates wired communication.

13. The array management device of claim 12, wherein
the derivation unit derives the waiting period so as to be longer when the configuration type indicates Internet communication than when the configuration type indicates LAN (Local Area Network) communication.

14. The array management device of claim 12, wherein
with respect to the given storage device to which access has failed, when the configuration type of the communication path indicates communication that cannot be temporarily shut down, the redundancy processing unit immediately executes redundancy processing on the plurality of storage devices other than the given storage device.

15. The array management device of claim 12, wherein
the holding unit further holds therein, with respect to each of the plurality of storage devices, information indicating whether the storage device protects data stored therein, and
with respect to the given storage device to which access has failed, the derivation unit derives the waiting period so as to be shorter when the information indicates that the given storage device does not protect data stored therein than when the information indicates that the given storage device protects data stored therein.

16. The array management device of claim 13, further comprising:
a request reception unit configured to receive an access request from an external device; and
a temporary writing unit configured to write, to each of the plurality of storage devices other than the given storage device to which access has failed, data to be written to the given storage device, wherein
the request reception unit receives a data writing request from the external device, and selects one or more storage devices each to which data is to be written among the plurality of storage devices, and
when the judgment unit judges that access to a given one of the one or more storage devices has failed, the redundancy processing unit controls the temporary writing unit to write the data within the waiting period derived by the derivation unit, and executes redundancy processing on the plurality of storage devices other than the given storage device after elapse of the waiting period.

17. The array management device of claim 16, wherein
the judgment unit includes:
a communication path state monitoring unit configured to monitor whether failure occurs in the communication path to each of the plurality of storage devices; and
a storage state monitoring unit configured to monitor whether storage failure occurs in each of the plurality of storage devices,
the communication path state monitoring unit transmits a response request to each of the plurality of storage devices, and when receiving no response to the response request from a given one of the plurality of storage devices, the communication path state monitoring unit judges that access to the given storage device has failed, and
when breakdown as the storage failure occurs in a given one of the plurality of storage devices, the storage state monitoring unit judges that access to the given storage device has failed.

18. The array management device of claim 17, wherein
the holding unit further holds therein, with respect to each of the plurality of storage devices:
a non-response flag in correspondence with the configuration type of the communication path, the non-response flag indicating whether the response has been received; and
a breakdown flag indicating whether breakdown occurs,
when receiving no response from a given one of the plurality of storage devices, the communication path state monitoring unit sets the non-response flag of the given storage device to have a value indicating that no response has been received,
when breakdown occurs in a given one of the plurality of storage devices, the storage state monitoring unit sets the breakdown flag of the given storage device to have a value indicating that breakdown occurs,
the redundancy processing unit includes:
an array state monitoring unit configured to monitor a state of an array configuration formed from a combination of the plurality of storage devices; and
a redundancy execution unit configured to execute redundancy processing, and
when the non-response flag of a given one of the plurality of storage devices has a value indicating that no response has been received, the array state monitoring unit judges that redundancy processing is to be executed when no response is received from the given storage device within the waiting period derived by the derivation unit, and
when the breakdown flag of a given one of the plurality of storage devices has a value indicating that breakdown occurs, the array state monitoring unit judges that redundancy processing is immediately to be executed.

19. The array management device of claim 18, further comprising:
a recovery processing unit configured to execute recovery processing when a given one of the plurality of storage devices to which access has failed recovers, the recovery processing being processing of writing, to the recovered storage device, data which has been written to other of the plurality of storage devices by the temporary writing unit, wherein
when the non-response flag of a given one of the plurality of storage devices has a value indicating that no response has been received and then a response is received from the given storage device within the waiting period derived by the derivation unit, the array state monitoring unit controls the recovery processing unit to execute recovery processing.

20. An array management method for use in an array management device that comprises: a holding unit configured to hold therein a configuration type of a communication path to each of a plurality of storage devices; a judgment unit; a derivation unit; and a redundancy processing unit, and executes redundancy processing on the plurality of storage devices, and controls access to each of the plurality of storage devices, the array management method comprising:
a check step of checking, by the judgment unit, whether access to each of the plurality of storage devices has succeeded or failed;
a first judgment step of judging, by the judgment unit, whether the check step checks that access to a given one of the plurality of storage devices has failed;
a derivation step of, when the first judgment step judges that the check step checks that access to the given storage device has failed, deriving, by the derivation unit, a waiting period for the given storage device in accordance with the configuration type of the communication path to the given storage device held in the holding unit, the waiting period being from when access to the given storage device has failed to when execution of redundancy processing is to be started;
a second judgment step of, when the first judgment step judges that the check step checks that access to the given storage device has failed, judging, by the redundancy execution unit, whether the waiting period has elapsed that is derived in the derivation step in accordance with the configuration type of the communication path to the given storage device; and
a redundancy execution step of, checking, by the judgment unit, whether access to the given storage device which has failed that is checked in the check step now succeeds or fails within the waiting period, judging, by the judgment unit, whether access to the given storage device which has failed that is checked in the check step now succeeds or fails is checked, and when the judgment unit does not checks that access to the given storage device which has failed now succeeds, executing, by the redundancy processing unit, redundancy processing on the plurality of storage devices other than the given storage device, wherein
the derivation step derives the waiting period so as to be longer when the configuration type indicates wireless communication than when the configuration type indicates wired communication.

21. An integrated circuit in an array management device that comprises a holding unit configured to hold therein a configuration type of a communication path to each of a plurality of storage devices, executes redundancy processing on a plurality of storage devices, and controls access to each of the plurality of storage devices, the integrated circuit comprising:
a judgment unit configured to judge whether access to each of the plurality of storage devices has succeeded or failed;
a holding unit configured to hold therein a configuration type of a communication path to each of the plurality of storage devices;
a derivation unit configured, with respect to each of the plurality of storage devices, to derive a waiting period in accordance with the configuration type held in the holding unit, the waiting period being from when access to the storage device has failed to when execution of redundancy processing is to be started; and
a redundancy processing unit configured, when the judgment unit judges that access to a given one of the plurality of storage devices has failed, and then does not judge that access to the given storage device has succeeded within the waiting period derived by the derivation unit in accordance with the configuration type of the communication path to the given storage device, to execute redundancy processing on the plurality of storage devices other than the given storage device, wherein
the derivation unit derives the waiting period so as to be longer when the configuration type indicates wireless communication than when the configuration type indicates wired communication.
